(19) United States
(12) Patent Application Publication
(10) Pub. No.: US 2022/0272706 A1
(43) Pub. Date: Aug. 25, 2022

(54) DOWNLINK CONTROL INFORMATION (DCI) BASED BEAM INDICATION FOR WIRELESS CELLULAR NETWORK

(71) Applicant: Intel Corporation, Santa Clara, CA (US)

(72) Inventors: Avik Sengupta, San Jose, CA (US); Alexei Davydov, Nizhny Novgorod (RU); Bishwarup Mondal, San Ramon, CA (US); Debdeep Chatterjee, San Jose, CA (US); Gang Xiong, Portland, OR (US)

(21) Appl. No.: 17/741,040

(22) Filed: May 10, 2022

Related U.S. Application Data
(63) Continuation-in-part of application No. PCT/US2022/012551, filed on Jan. 14, 2022.
(60) Provisional application No. 63/187,292, filed on May 11, 2021.
(60) Provisional application No. 63/138,282, filed on Jan. 15, 2021.
(60) Provisional application No. 63/141,398, filed on Jan. 25, 2021.

(51) Int. Cl. H04W 72/04

(52) U.S. Cl. CPC H04W 72/0473

(57) ABSTRACT

Various embodiments herein provide techniques for downlink control information (DCI) based beam indication in a wireless cellular network. Other embodiments may be described and claimed.

### CROSS REFERENCE TO RELATED APPLICATION

The present application claims priority to U.S. Provisional Patent Application No. 63/187,292, which was filed May 11, 2021; U.S. Provisional Patent Application No. 63/138,282, which was filed Jan. 15, 2021; and U.S. Provisional Patent Application No. 63/141,398, which was filed Jan. 25, 2021.

### FIELD

Various embodiments generally may relate to the field of wireless communications. For example, some embodiments may relate to downlink control information (DCI)-based beam indication.

### BACKGROUND

Various embodiments generally may relate to the field of wireless communications. In 3GPP Release (Rel)-15 and Rel-16 New Radio (NR) multiple input, multiple output (MIMO), downlink (DL) beam indication for physical downlink shared channel (PDSCH) is performed via transmission control indicator (TCI) state indication, wherein radio resource control (RRC) signaling is used to configure a set of TCI states to the user equipment (UE), a medium access control (MAC) control element (CE) command is used to activate at most 8 TCI states and, when supported, a downlink control channel (DCI) can indicate one of the 8 activated TCI states via a 3-bit mapping. For physical downlink control channel (PDCCH), the TCI state is activated via MAC-CE only. Further, for uplink (UL), PUCCH spatial relation information is activated via MAC-CE and, for sounding reference signal (SRS), spatial relation information is configured per resource and indicated by the SRS resource indicator (SRI) field in DCI. For semi-persistent SRS, MAC-CE activation of spatial relation information is also supported. In order to unify the beam indication framework, the concept of TCI state for uplink or a joint uplink/downlink TCI has been agreed to be supported for Rel-17 NR.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 schematically illustrates downlink control information (DCI)-based transmission control indicator (TCI) state indication, in accordance with various embodiments.

FIG. 2 schematically illustrates multiple TCI state indication via DCI, in accordance with various embodiments.

FIG. 3 schematically illustrates group-based DCI activation for TCI states, in accordance with various embodiments.

FIG. 4 schematically illustrates enhanced TCI state activation/deactivation for user equipment (UE)-specific physical downlink shared channel (PDSCH) medium access control (MAC) control element (CE), in accordance with various embodiments.

FIG. 5 schematically illustrates a wireless network in accordance with various embodiments.

FIG. 6 schematically illustrates components of a wireless network in accordance with various embodiments.

FIG. 7 is a block diagram illustrating components, according to some example embodiments, able to read instructions from a machine-readable or computer-readable medium (e.g., a non-transitory machine-readable storage medium) and perform any one or more of the methodologies discussed herein.

FIGS. 8-14 illustrate example processes in accordance with various embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

Embodiments herein may relate to enhancements for MIMO beam management. For example, embodiments may include techniques for DCI-based beam indication.

As discussed above, in order to unify the beam indication framework, the concept of TCI state for uplink or a joint uplink/downlink TCI has been agreed to be supported for Rel-17 NR. In this case, if both DL and UL beam indication is performed via TCI state indication, a more unified TCI state activation framework is needed and is described herein in accordance with various embodiments.

In one embodiment, uplink TCI states share the same pool of TCI state IDs with downlink and/or joint downlink/uplink TCI states. The TCI states configured by RRC can be activated by MAC-CE signaling.

In one embodiment, the uplink TCI state configuration optionally includes parameters for PUCCH which can be applicable when the TCI state is activated for PUCCH. As an example, the UL TCI state may include some or all of the following information:

| | |
|---|---|
| UplinkTCI-State ::= | SEQUENCE { |
| tci-StateId | TCI-StateId, |

| | |
|---|---|
| pucch-PathlossReferenceRS-Id | PUCCH-PathlossReferenceRS-Id, OPTIONAL, |

| | |
|---|---|
| p0-PUCCH-Id | P0-PUCCH-Id, OPTIONAL, |
| closedLoopIndex | ENUMERATED { i0, i1 } OPTIONAL, |
| qcl-Type1 | QCL-Info, |
| qcl-Type2 | QCL-Info OPTIONAL, -- Need R |

. . .
}

| | |
|---|---|
| QCL-Info ::= | SEQUENCE { |
| cell | ServCellIndex OPTIONAL, -- Need R |
| bwp-Id | BWP-Id OPTIONAL, -- Cond CSI-RS-Indicated |
| referenceSignal | CHOICE { |
| csi-rs | NZP-CSI-RS-ResourceId, |
| ssb | SSB-Index, |
| srs | SEQUENCE { |
| resourceId | SRS-ResourceId, |
| uplinkBWP | BWP-Id |
| } | |
| }, | |
| qcl-Type | ENUMERATED {typeA, typeB, typeC, typeD}, |
| . . . | |
| } | |

In one embodiment, for UL or joint TCI indication to update the common UL beam, the power control parameters for PUCCH, PUSCH and SRS (e.g., pathloss reference RS ID, P0, alpha and closed loop index) are not configured via TCI state. Rather, one or more of the power control parameters may be configured in PUCCH-PowerControl and PUSCH-PowerControl and updated via MAC-CE. The MAC-CE may update the pathloss reference RS for both PUCCH and PUSCH wherein a mapping between the activated TCI state ID and the pathloss reference RS ID may be included in the MAC-CE. Additionally, for PUSCH, the MAC-CE activating the TCI state codepoints may also include mapping between the TCI states and the SRI. In case UL DCI formats 0_1, 0_2 are used for beam indication, the SRI field mapping may be used for TCI state indication and power control parameter selection simultaneously.

In one embodiment, the default pathloss reference RS may be the same periodic downlink RS which is used for pathloss measurement for PUCCH and PUSCH power control for unified TCI framework with common UL beam for PUCCH and PUSCH in the case when PL-RS is not configured to the UE for PUCCH and PUSCH. The default PL-RS in this case may be the QCL-Type D source RS which indicated in the activated joint or UL TCI state provided it is a periodic DL RS.

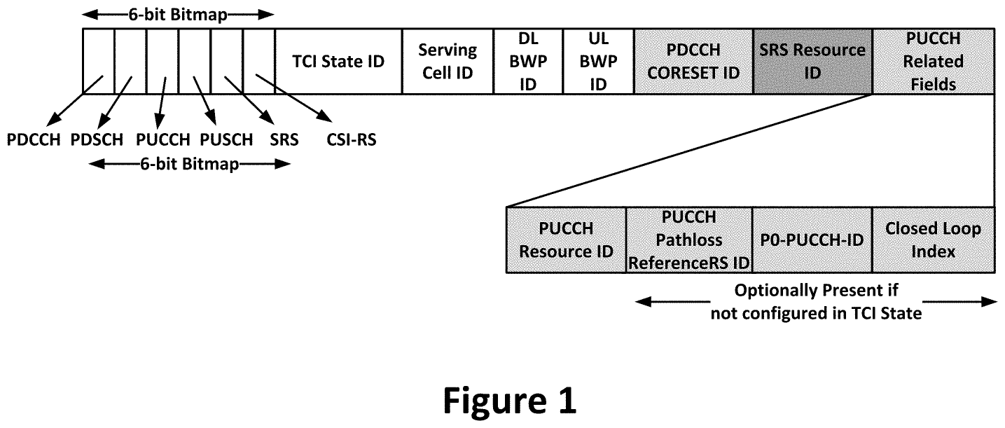

In one embodiment, the uplink TCI indication or the joint uplink/downlink TCI state indication for TCI state IDs activated by MAC-CE may be performed through DCI signaling. In some embodiments, a new DCI format may be designed for this purpose, wherein the DCI may include some or all of the following information:
Channels and reference signals to which the indicated TCI state is applicable.
TCI State ID of the uplink, downlink or joint uplink/downlink TCI state indication which is applicable to the channels/reference signals indicated by the bitmap.
Serving Cell ID and bandwidth part (BWP) ID where the indicated TCI state is applicable.
Optionally additional fields related to specific channels and reference signals are also present as shown in FIG. 1.

In one embodiment, when all fields of the 6-bit bitmap in FIG. 1 are set to l's, it indicates that the signaled TCI state is a common beam indication applicable to all the channels for both transmit (Tx) and receive (Rx) beams. In one example of this embodiment, the TCI state ID may correspond to only a joint uplink/downlink TCI state when common beam indication is used.

In another embodiment, the bitmap indicating which channels the TCI state applies to may be less than 5 bits. For example, it may be only 3 bits and contain only indications for UL channels and reference signals (RSs) e.g., PUCCH, PUSCH and SRS.

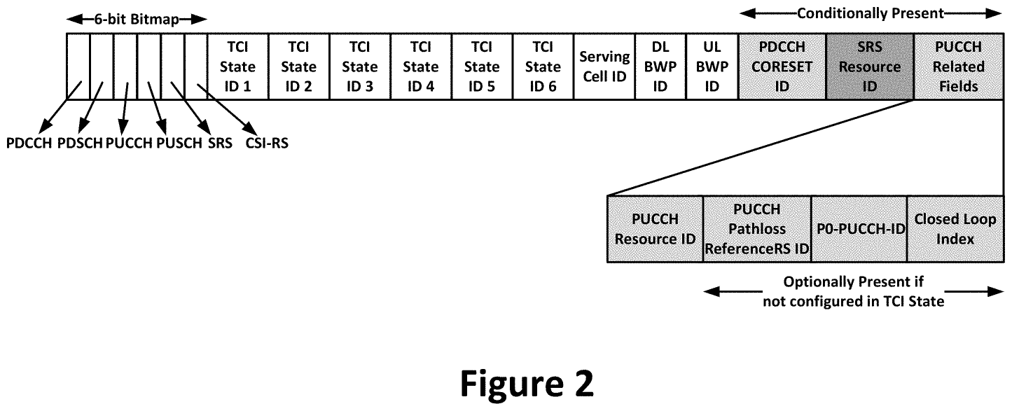

In another embodiment, the DCI indication can contain different TCI state IDs which are applicable to the channels indicated by the bitmap as shown in FIG. 2. Here TCI state IDs can correspond to uplink, downlink or joint uplink/downlink TCI states and TCI states are applied in order to the channels indicated by the bit map. For example, if the bitmap indicates 101000, the TCI state ID1 is applicable to PDCCH and TCI state ID 2 is applicable to PUCCH.

In one embodiment, when the bit map is all 1s, the first TCI Stated ID is applied for all channels as common beam indication.

In another embodiment, for PUCCH beam indication, the indicated TCI state can apply to all configured PUCCH resources. Alternately, the UE can be also indicated with a PUCCH resource group containing a set of PUCCH resources to which the newly indicated TCI state is applicable. In this case, group ID and the indicated TCI state associated with the group ID can be included in the DCI. Note that the PUCCH group can be configured by higher layers via RRC signaling.

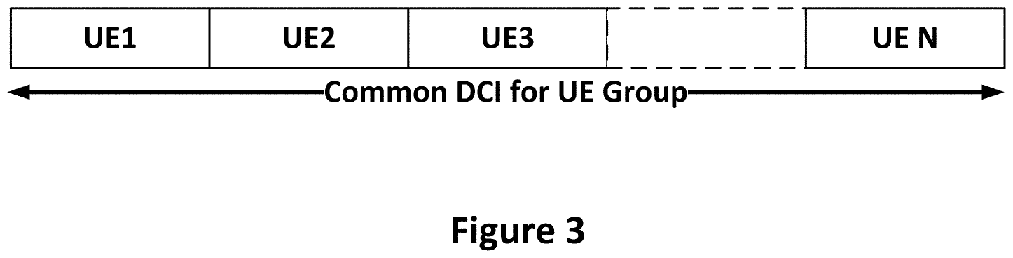

In another embodiment, the activation DCI can also be applicable to a group of UEs. In option of this embodiment, the activation DCI is transmitted in a group-common PDCCH monitored in a common search space and a DCI with CRC scrambled by a group common radio network temporary identifier (RNTI), e.g., G-RNTI. In this option, the activation DCI may be, e.g., of the form of either single TCI activation as shown in FIG. 1 or multiple TCI state activation as shown in FIG. 2. In another option of this embodiment, the activation DCI for group common activation may have activation for multiple users appended as shown in FIG. 3. UEs may be configured by UE-specific RRC signaling or another group common DCI to identify its respective position in the DCI and select the correct TCI activation. In this option, the activation DCI can also be sent over a PDCCH monitored in a common search space (CSS) and the DCI is scrambled by a group-common RNTI. Alternately, PDCCH may also be monitored in a UE-specific search space (USS) with the DCI scrambled by C-RNTI.

In one embodiment, an uplink beam indication or TCI state activation, separate from DL beam indication, is performed using a joint DL/UL TCI state which contains quasi co-location (QCL) source reference signals for both DL and UL beams. In one example, the UL beam indication is a common beam indication which applies to all UL channels. In one embodiment, the UL beam indication via joint DL/UL TCI states is performed by activating a set of N joint DL/UL TCI states from the list of RRC configured TCI states and the TCI state to be applied is signaled to the UE via a downlink DCI e.g., DCI format 1_1, 1_2 through the Transmission configuration indication field when tci-PresentInDCI is enabled. Additionally, for UL separate beam indication, the UE may be signaled dynamically, through a new field in DCI to only apply the UL QCL source and ignore the configured DL QCL source in the joint TCI state. In another example, the configured TCI state will be such that the DL QCL source will be restricted to remain identical to the current DL QCL source e.g., the DL beam is unchanged and only the UL source RS is updated. In another embodiment, the UL QCL source RS can be activated by a joint DL/UL TCI state signaled to the UE via an uplink DCI e.g., format 0_1, 0_2. The UE in this case updates only the UL beam indicated by the joint TCI state and ignores the DL QCL source. In one embodiment, when DCI format 0_1, 0_2 are used to active a UL TCI state, the SRI field in the DCI can be used to indicate the TCI state ID.

In one embodiment, the uplink beam indication or TCI state activation, separate from DL beam indication, is performed using a separate UL TCI state which contains QCL source reference signals for only UL. In one example, the beam indication is a common beam indication which applies to PUCCH/PUSCH/SRS. In one embodiment, the separate UL beam indication via UL TCI state activation may be signaled to the UE via the TCI field in a downlink DCI format e.g., 1_1, 1_2. In one example, the UL TCI shares the same pool of TCI states with DL and/or joint DL/UL TCI and the UE can discern that the signaled TCI is applicable to UL beam indication based on the TCI state index of the activated TCI state list, where the TCI states are activated via a MAC-CE. In one embodiment, when DL DCI formats 1_1, 1_2 are used for UL TCI state activation, the UE is signaled a known reserved field in the DCI which indicates that the DL DCI is meant for UL TCI activation and the UE ignores the DL scheduling grant and updates the UL TCI state indicated in the Transmission configuration indication field of the DCI. In this case, the UE may also transmit a HARQ ACK feedback on the indicated PUCCH resource to indicate the successful decoding of the DCI to the base station. In an alternative, a 1-bit indication can be included in DCI formats 1_1,1_2 wherein the value 0 indicates that the DCI is a DL scheduling and beam indication DCI and a value 1 indicates that the DCI is UL beam indication DCI and the UE ignores the DL scheduling information and updates the UL TCI state with the information in the Transmission configuration indication field in the DCI.

In one embodiment, the UE is configured with a new RNTI associated with DCI based beam indication (e.g., BM-RNTI). The UE expects to receive the beam indication DCI in a UE-specific search space set with the CRC scrambled by a beam indication RNTI. The DCI format for this indication may be DCI formats 1_0, 1_1, 1_2 or 0_0, 0_1, 0_2 or a new DCI format. In one example, when an existing DCI format with CRC scrambled by beam indication RNTI is used, some known state in the existing fields in the DCI may be jointly used to indicate to the UE that the DCI is a beam indication DCI. For instance, the frequency domain resource assignment (FDRA) field of the DCI format can be set to all 1's to indicate to the UE that the DCI is a beam indication DCI. In another example, for a DCI with CRC scrambled with beam indication RNTI, the UE ignores the FDRA field if any, e.g., the DCI is sent without an associated downlink or uplink grant. In another embodiment, the when the UE receives a DCI with CRC scrambled by beam indication RNTI, the UE does not expect an associated DL or UL grant and is expected to transmit an ACK/NACK feedback for the DCI in the PUCCH resource indicated by the PRI field. In another embodiment, the DCI indicating the TCI state can contain the CC index to which the indicated TCI state is applicable.

In one embodiment, when a UE is configured with two priorities for HARQ-ACK feedback, the HARQ ACK/NACK feedback associated with the beam indication DCI (for example, DCI 1_1, 1_2) without a DL grant is always mapped to the high priority HARQ-ACK codebook and thereby to the PUCCH-Config associated with priority index 1.

In one embodiment, the beam indication HARQ-ACK feedback may be mapped to either priority index 0 or priority index 1, but in the case when the PUCCH resource carrying the HARQ-ACK feedback overlaps in time with PUCCH resource carrying other UCI of different priority, the beam indication HARQ-ACK feedback may be prioritized and the other UCI may be dropped.

In another embodiment, if the PUCCH resource carrying the beam indication HARQ-ACK feedback overlaps in time with PUCCH resource carrying other UCI of same priority, the HARQ-ACK feedback may be multiplexed with the other UCI following Rel-15/16 UCI multiplexing rules.

In another embodiment, PUCCH with beam indication HARQ-ACK feedback (irrespective of priority) is not expected to overlap with a PUCCH resource mapped to priority index 1.

In one embodiment, when any prioritization is used for UCI carried in a PUCCH or PUSCH, the beam indication HARQ-ACK feedback may be always prioritized.

In another embodiment, the beam indication RNTI can also be used to scramble the CRC of a group-common DCI which can indicate TCI state update for multiple UEs in a group.

In another embodiment, in case when no explicit TCI state indication is included in the DCI, or some known state in the existing fields in the DCI may indicate no explicit TCI state, UE may assume TCI state for DL or UL transmission is based on the TCI state for CORESET which is used for corresponding PDCCH transmission.

Shared TCI State Pool Design

In one embodiment, the TCI state pool for separate UL-only beam indication is shared with joint DL/UL TCI state e.g., the same TCI state from RANI perspective can be used for both joint beam indication as well as separate UL-only beam indication. In this case, the source reference signals for determining the UL transmit spatial filter which are not applicable for determining the source of QCL Type D RS for downlink TCI can be optionally configured for the joint DL/UL TCI state when it is used for UL-only beam indication. For example, when SRS is optionally configured as a source RS, it may not be applicable for DL QCL Type D source RS but is used for determining the UL transmit spatial filter. In an embodiment, when such RS is configured in the joint DL/UL TCI state, the UE may assume that the TCI state is used for separate UL-only beam indication.

In one embodiment, the UE may be configured with DCI codepoints for DL only beam indication using DL TCI states, UL only beam indication using joint DL/UL TCI state, or joint DL/UL beam indication using DL/UL TCI states by MAC-CE signaling wherein, the MAC-CE will additionally contain signaling for the UE to differentiate between joint DL/UL TCI and UL only TCI state when they are configured using the same TCI state pool.

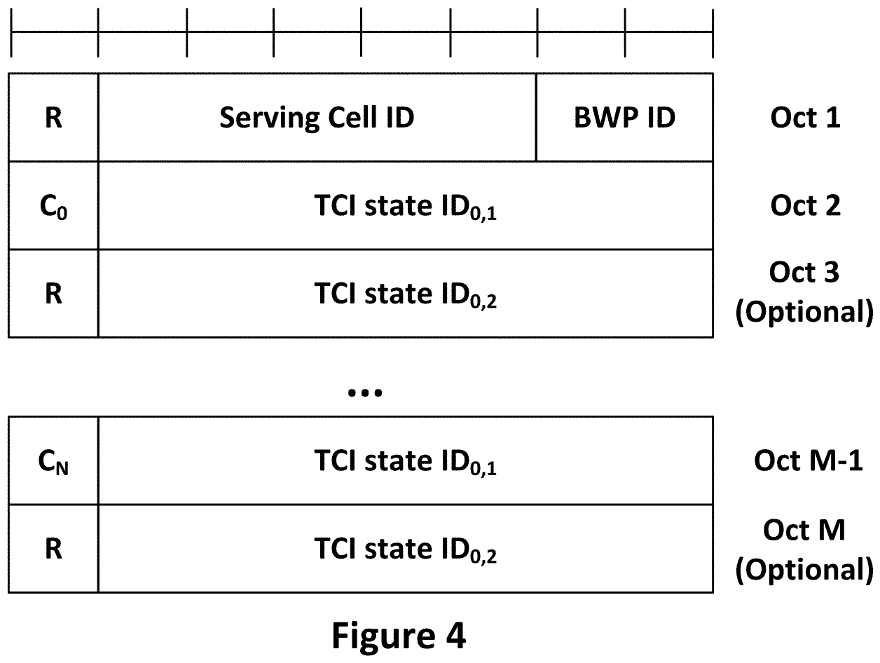

In one example, the Rel-16 Enhanced TCI States Activation/Deactivation for UE-specific PDSCH MAC CE (see 3GPP TS 38.321 v16.3.0) shown in FIG. 4 can be used for this purpose. The Reserve field can be used for this indication and the combination of the Cᵢ bit and R bit can be interpreted as follows:
(Cᵢ,R)=(0, 0)→single TRP with single TCI state configured to the i-th codepoint. The TCI state can be DL TCI or joint DL/UL TCI
(Cᵢ,R)=(1, 0)→multi-TRP with 2 DL TCI states configured to the i-th codepoint
(Cᵢ,R)=(0, 1)→single TRP with single TCI state configured to the i-th codepoint. The TCI state is a joint DL/UL TCI configured for UL only beam indication
(Cᵢ,R)=(1, 1)→Reserved

In another example, the UE (Cᵢ,R) (1, 1) can imply that a DL TCI state applicable to DL-only beam indication is configured to the 1st TCI state of the codepoint and a joint DL/UL TCI state applicable to UL-only beam indication is configured to the 2nd TCI state of the codepoint.

In these examples, based on the MAC-CE configuration, the UE is able to determine the applicability of the configured TCI state to DL-only, UL-only or joint DL/UL when a codepoint is indicated via DCI for beam indication.

Separate TCI State Pool Design

In one embodiment, the TCI state pool for separate UL-only beam indication is separate from joint DL/UL TCI state e.g., the different TCI states are configured from RANI perspective for joint DL/UL beam indication and separate UL-only beam indication respectively. In one embodiment, the UE can be configured by MAC-CE with DCI codepoints for DL-only beam indication using DL TCI state, UL-only beam indication using UL TCI state or joint DL/UL beam indication using joint DL/UL TCI state. In one embodiment, the TCI States Activation/Deactivation for UE-specific PDSCH MAC-CE (see TS 38.321) or the Enhanced TCI States Activation/Deactivation for UE-specific PDSCH MAC-CE (see TS 38.321) with Cᵢ=0 ∀i, can re-used, which allows the configuration of single TCI state per DCI codepoint. The UE is able to determine the applicability of the beam indication based on the configured TCI state type e.g., DL-only, UL-only or joint DL/UL beam indication. In another embodiment, for the case of Enhanced TCI States Activation/Deactivation for UE-specific PDSCH MAC-CE (e.g., shown in FIG. 4), when Cᵢ=1 and R=1 for a given codepoint i, the UE expects to be configured with two TCI states in the i-th codepoint wherein the first TCI state is a DL-only TCI state applicable to separate DL-only beam indication and the 2nd TCI state is a UL-only TCI state applicable to separate UL-only beam indication.

In one embodiment, when the UE is indicated by a DCI to activate a TCI state for DL or UL or DL and UL, the UE may not apply the indicated TCI state before an acknowledgement for DCI decoding has been transmitted. In one example, the TCI state can be a joint DL/UL TCI state which applies to all DL and UL channels/RSs. In another example, the TCI state can be a DL only or UL only TCI state. In another embodiment, the DCI indicating the TCI state can be a scheduling DCI and the acknowledgement of the DCI decoding can be the acknowledgement of the PDSCH or PUSCH scheduled by the DCI. In one example, the UE can transmit the acknowledgement for decoding of the beam indication and/or scheduling DCI using the beam corresponding to the already activated TCI state or transmit spatial filter without applying the TCI state update indicated in the DCI. In one embodiment, the indicated TCI state can be applied X OFDM symbols after transmission of the acknowledgement of the decoding of the beam indication DCI wherein, the value of X is a UE capability and can be signaled to the gNB. In one example, the value of X can be 28 OFDM symbols, while in another example, the value of X can 1 OFDM symbol. In one embodiment, the X OFDM symbols or Y ms are counted from the first symbol of the PUCCH resource which carries the acknowledgement of the DCI indicating the TCI state or the acknowledgement of the PDSCH scheduled by a downlink DCI which also indicates a TCI state. In another embodiment, the X OFDM symbols or Y ms are counted from the last symbol of the PUCCH resource which carries the acknowledgement of the DCI indicating the TCI state or the acknowledgement of the PDSCH scheduled by a downlink DCI which also indicates a TCI state.

Note that this PUCCH resource may be the PUCCH resource which is determined in accordance with the PUCCH resource indicator (PRI) and starting CCE index or the configured PUCCH resource for beam indication acknowledgement. Alternatively, this PUCCH resource may be the PUCCH resource which is determined after handling the overlapping between another PUCCH and/or PUSCH or semi-static DL symbols or SSB transmission.

Further, when repetition is configured for PUCCH transmission, the PUCCH resource may be the actual transmission after handling the collision between semi-static DL symbols or SSB transmission as defined in Section 9.2.6 in TS38.213 v16.2.0.

In another embodiment, the DCI can be a scheduling DCI which has additionally a separate acknowledgement which is transmitted independent of the acknowledgment of the PDSCH or PUSCH scheduled by the DCI. In yet another embodiment, the UE may use the TCI state indicated by the TCI state activation DCI immediately on reception of such DCI. In one example, if the DCI is a scheduling DCI, the UE uses the indicated TCI state for reception of the PDSCH or PUSCH scheduled by the DCI. In another example, the UE also uses the TCI state indicated in the DCI to transmit the acknowledgement for the decoding of the DCI.

### Systems and Implementations

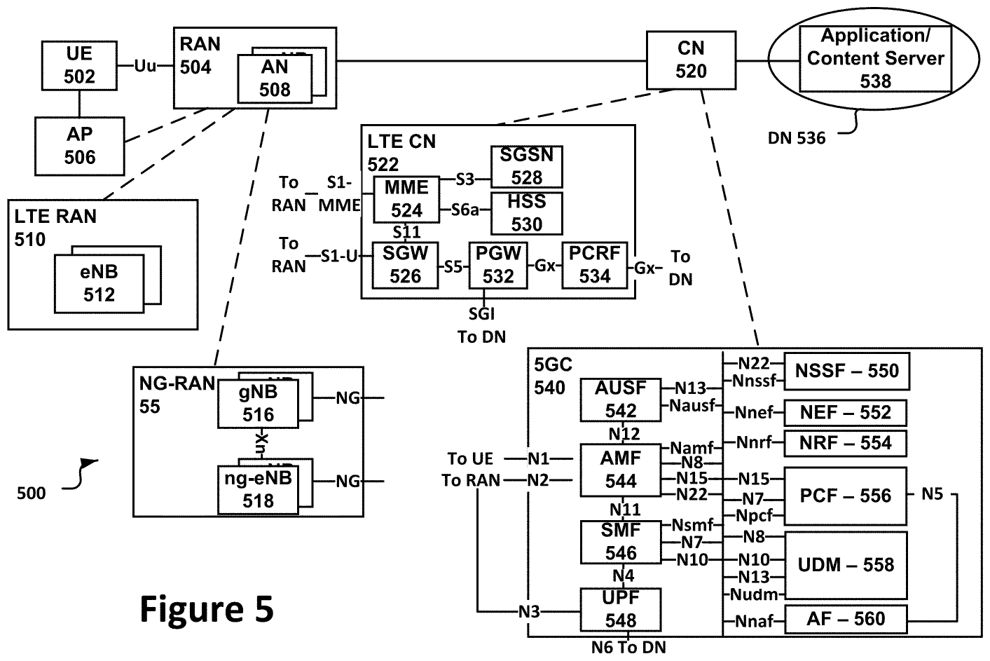

FIGS. 5-7 illustrate various systems, devices, and components that may implement aspects of disclosed embodiments.

FIG. 5 illustrates a network 500 in accordance with various embodiments. The network 500 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 500 may include a UE 502, which may include any mobile or non-mobile computing device designed to communicate with a RAN 504 via an over-the-air connection. The UE 502 may be communicatively coupled with the RAN 504 by a Uu interface. The UE 502 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 500 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 502 may additionally communicate with an AP 506 via an over-the-air connection. The AP 506 may manage a WLAN connection, which may serve to offload some/all network traffic from the RAN 504. The connection between the UE 502 and the AP 506 may be consistent with any IEEE 802.11 protocol, wherein the AP 506 could be a wireless fidelity (Wi-Fi®) router. In some embodiments, the UE 502, RAN 504, and AP 506 may utilize cellular-WLAN aggregation (for example, LWA/LWIP). Cellular-WLAN aggregation may involve the UE 502 being configured by the RAN 504 to utilize both cellular radio resources and WLAN resources.

The RAN 504 may include one or more access nodes, for example, AN 508. AN 508 may terminate air-interface protocols for the UE 502 by providing access stratum protocols including RRC, PDCP, RLC, MAC, and L1 protocols. In this manner, the AN 508 may enable data/voice connectivity between CN 520 and the UE 502. In some embodiments, the AN 508 may be implemented in a discrete device or as one or more software entities running on server computers as part of, for example, a virtual network, which may be referred to as a CRAN or virtual baseband unit pool. The AN 508 be referred to as a BS, gNB, RAN node, eNB, ng-eNB, NodeB, RSU, TRxP, TRP, etc. The AN 508 may be a macrocell base station or a low power base station for providing femtocells, picocells or other like cells having smaller coverage areas, smaller user capacity, or higher bandwidth compared to macrocells.

In embodiments in which the RAN 504 includes a plurality of ANs, they may be coupled with one another via an X2 interface (if the RAN 504 is an LTE RAN) or an Xn interface (if the RAN 504 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 504 may each manage one or more cells, cell groups, component carriers, etc. to provide the UE 502 with an air interface for network access. The UE 502 may be simultaneously connected with a plurality of cells provided by the same or different ANs of the RAN 504. For example, the UE 502 and RAN 504 may use carrier aggregation to allow the UE 502 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 504 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 502 or AN 508 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 504 may be an LTE RAN 510 with eNBs, for example, eNB 512. The LTE RAN 510 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 504 may be an NG-RAN 514 with gNBs, for example, gNB 516, or ng-eNBs, for example, ng-eNB 518. The gNB 516 may connect with 5G-enabled UEs using a 5G NR interface. The gNB 516 may connect with a 5G core through an NG interface, which may include an N2 interface or an N3 interface. The ng-eNB 518 may also connect with the 5G core through an NG interface, but may connect with a UE via an LTE air interface. The gNB 516 and the ng-eNB 518 may connect with each other over an Xn interface.

In some embodiments, the NG interface may be split into two parts, an NG user plane (NG-U) interface, which carries traffic data between the nodes of the NG-RAN 514 and a UPF 548 (e.g., N3 interface), and an NG control plane (NG-C) interface, which is a signaling interface between the nodes of the NG-RAN514 and an AMF 544 (e.g., N2 interface).

The NG-RAN 514 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 502 can be configured with multiple BWPs where each BWP configuration has a different SCS. When a BWP change is indicated to the UE 502, the SCS of the transmission is changed as well. Another use case example of BWP is related to power saving. In particular, multiple BWPs can be configured for the UE 502 with different amount of frequency resources (for example, PRBs) to support data transmission under different traffic loading scenarios. A BWP containing a smaller number of PRBs can be used for data transmission with small traffic load while allowing power saving at the UE 502 and in some cases at the gNB 516. A BWP containing a larger number of PRBs can be used for scenarios with higher traffic load.

The RAN 504 is communicatively coupled to CN 520 that includes network elements to provide various functions to support data and telecommunications services to customers/subscribers (for example, users of UE 502). The components of the CN 520 may be implemented in one physical node or separate physical nodes. In some embodiments, NFV may be utilized to virtualize any or all of the functions provided by the network elements of the CN 520 onto physical compute/storage resources in servers, switches, etc. A logical instantiation of the CN 520 may be referred to as a network slice, and a logical instantiation of a portion of the CN 520 may be referred to as a network sub-slice.

In some embodiments, the CN 520 may be an LTE CN 522, which may also be referred to as an EPC. The LTE CN 522 may include MME 524, SGW 526, SGSN 528, HSS 530, PGW 532, and PCRF 534 coupled with one another over interfaces (or “reference points”) as shown. Functions of the elements of the LTE CN 522 may be briefly introduced as follows.

The MME 524 may implement mobility management functions to track a current location of the UE 502 to facilitate paging, bearer activation/deactivation, handovers, gateway selection, authentication, etc.

The SGW 526 may terminate an Si interface toward the RAN and route data packets between the RAN and the LTE CN 522. The SGW 526 may be a local mobility anchor point for inter-RAN node handovers and also may provide an anchor for inter-3GPP mobility. Other responsibilities may include lawful intercept, charging, and some policy enforcement.

The SGSN 528 may track a location of the UE 502 and perform security functions and access control. In addition, the SGSN 528 may perform inter-EPC node signaling for mobility between different RAT networks; PDN and S-GW selection as specified by MME 524; MME selection for handovers; etc. The S3 reference point between the MME 524 and the SGSN 528 may enable user and bearer information exchange for inter-3GPP access network mobility in idle/active states.

The HSS 530 may include a database for network users, including subscription-related information to support the network entities' handling of communication sessions. The HSS 530 can provide support for routing/roaming, authentication, authorization, naming/addressing resolution, location dependencies, etc. An S6a reference point between the HSS 530 and the MME 524 may enable transfer of subscription and authentication data for authenticating/authorizing user access to the LTE CN 520.

The PGW 532 may terminate an SGi interface toward a data network (DN) 536 that may include an application/content server 538. The PGW 532 may route data packets between the LTE CN 522 and the data network 536. The PGW 532 may be coupled with the SGW 526 by an S5 reference point to facilitate user plane tunneling and tunnel management. The PGW 532 may further include a node for policy enforcement and charging data collection (for example, PCEF). Additionally, the SGi reference point between the PGW 532 and the data network 536 may be an operator external public, a private PDN, or an intra-operator packet data network, for example, for provision of IMS services. The PGW 532 may be coupled with a PCRF 534 via a Gx reference point.

The PCRF 534 is the policy and charging control element of the LTE CN 522. The PCRF 534 may be communicatively coupled to the app/content server 538 to determine appropriate QoS and charging parameters for service flows. The PCRF 532 may provision associated rules into a PCEF (via Gx reference point) with appropriate TFT and QCI.

In some embodiments, the CN 520 may be a 5GC 540. The 5GC 540 may include an AUSF 542, AMF 544, SMF 546, UPF 548, NSSF 550, NEF 552, NRF 554, PCF 556, UDM 558, and AF 560 coupled with one another over interfaces (or “reference points”) as shown. Functions of the elements of the 5GC 540 may be briefly introduced as follows.

The AUSF 542 may store data for authentication of UE 502 and handle authentication-related functionality. The AUSF 542 may facilitate a common authentication framework for various access types. In addition to communicating with other elements of the 5GC 540 over reference points as shown, the AUSF 542 may exhibit an Nausf service-based interface.

The AMF 544 may allow other functions of the 5GC 540 to communicate with the UE 502 and the RAN 504 and to subscribe to notifications about mobility events with respect to the UE 502. The AMF 544 may be responsible for registration management (for example, for registering UE 502), connection management, reachability management, mobility management, lawful interception of AMF-related events, and access authentication and authorization. The AMF 544 may provide transport for SM messages between the UE 502 and the SMF 546, and act as a transparent proxy for routing SM messages. AMF 544 may also provide transport for SMS messages between UE 502 and an SMSF. AMF 544 may interact with the AUSF 542 and the UE 502 to perform various security anchor and context management functions. Furthermore, AMF 544 may be a termination point of a RAN CP interface, which may include or be an N2 reference point between the RAN 504 and the AMF 544; and the AMF 544 may be a termination point of NAS (N1) signaling, and perform NAS ciphering and integrity protection. AMF 544 may also support NAS signaling with the UE 502 over an N3 IWF interface.

The SMF 546 may be responsible for SM (for example, session establishment, tunnel management between UPF 548 and AN 508); UE IP address allocation and management (including optional authorization); selection and control of UP function; configuring traffic steering at UPF 548 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 544 over N2 to AN 508; and determining SSC mode of a session. SM may refer to management of a PDU session, and a PDU session or “session” may refer to a PDU connectivity service that provides or enables the exchange of PDUs between the UE 502 and the data network 536.

The UPF 548 may act as an anchor point for intra-RAT and inter-RAT mobility, an external PDU session point of interconnect to data network 536, and a branching point to support multi-homed PDU session. The UPF 548 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 548 may include an uplink classifier to support routing traffic flows to a data network.

The NSSF 550 may select a set of network slice instances serving the UE 502. The NSSF 550 may also determine allowed NSSAI and the mapping to the subscribed S-NSSAIs, if needed. The NSSF 550 may also determine the AMF set to be used to serve the UE 502, or a list of candidate AMFs based on a suitable configuration and possibly by querying the NRF 554. The selection of a set of network slice instances for the UE 502 may be triggered by the AMF 544 with which the UE 502 is registered by interacting with the NSSF 550, which may lead to a change of AMF. The NSSF 550 may interact with the AMF 544 via an N22 reference point; and may communicate with another NSSF in a visited network via an N31 reference point (not shown). Additionally, the NSSF 550 may exhibit an Nnssf service-based interface.

The NEF 552 may securely expose services and capabilities provided by 3GPP network functions for third party, internal exposure/re-exposure, AFs (e.g., AF 560), edge computing or fog computing systems, etc. In such embodiments, the NEF 552 may authenticate, authorize, or throttle the AFs. NEF 552 may also translate information exchanged with the AF 560 and information exchanged with internal network functions. For example, the NEF 552 may translate between an AF-Service-Identifier and an internal 5GC information. NEF 552 may also receive information from other NFs based on exposed capabilities of other NFs. This information may be stored at the NEF 552 as structured data, or at a data storage NF using standardized interfaces. The stored information can then be re-exposed by the NEF 552 to other NFs and AFs, or used for other purposes such as analytics. Additionally, the NEF 552 may exhibit an Nnef service-based interface.

The NRF 554 may support service discovery functions, receive NF discovery requests from NF instances, and provide the information of the discovered NF instances to the NF instances. NRF 554 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 554 may exhibit the Nnrf service-based interface.

The PCF 556 may provide policy rules to control plane functions to enforce them, and may also support unified policy framework to govern network behavior. The PCF 556 may also implement a front end to access subscription information relevant for policy decisions in a UDR of the UDM 558. In addition to communicating with functions over reference points as shown, the PCF 556 exhibit an Npcf service-based interface.

The UDM 558 may handle subscription-related information to support the network entities' handling of communication sessions, and may store subscription data of UE 502. For example, subscription data may be communicated via an N8 reference point between the UDM 558 and the AMF 544. The UDM 558 may include two parts, an application front end and a UDR. The UDR may store subscription data and policy data for the UDM 558 and the PCF 556, and/or structured data for exposure and application data (including PFDs for application detection, application request information for multiple UEs 502) for the NEF 552. The Nudr service-based interface may be exhibited by the UDR 221 to allow the UDM 558, PCF 556, and NEF 552 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 558 may exhibit the Nudm service-based interface.

The AF 560 may provide application influence on traffic routing, provide access to NEF, and interact with the policy framework for policy control.

In some embodiments, the 5GC 540 may enable edge computing by selecting operator/3rd party services to be geographically close to a point that the UE 502 is attached to the network. This may reduce latency and load on the network. To provide edge-computing implementations, the 5GC 540 may select a UPF 548 close to the UE 502 and execute traffic steering from the UPF 548 to data network 536 via the N6 interface. This may be based on the UE subscription data, UE location, and information provided by the AF 560. In this way, the AF 560 may influence UPF (re)selection and traffic routing. Based on operator deployment, when AF 560 is considered to be a trusted entity, the network operator may permit AF 560 to interact directly with relevant NFs. Additionally, the AF 560 may exhibit an Naf service-based interface.

The data network 536 may represent various network operator services, Internet access, or third party services that may be provided by one or more servers including, for example, application/content server 538.

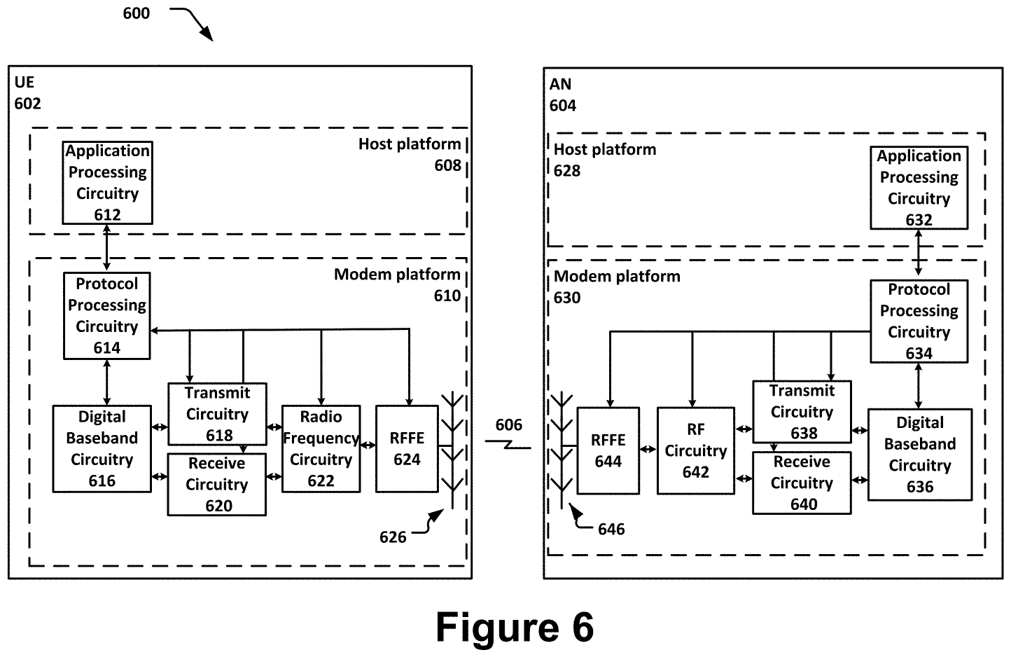

FIG. 6 schematically illustrates a wireless network 600 in accordance with various embodiments. The wireless network 600 may include a UE 602 in wireless communication with an AN 604. The UE 602 and AN 604 may be similar to, and substantially interchangeable with, like-named components described elsewhere herein.

The UE 602 may be communicatively coupled with the AN 604 via connection 606. The connection 606 is illustrated as an air interface to enable communicative coupling, and can be consistent with cellular communications protocols such as an LTE protocol or a 5G NR protocol operating at mmWave or sub-6 GHz frequencies.

The UE 602 may include a host platform 608 coupled with a modem platform 610. The host platform 608 may include application processing circuitry 612, which may be coupled with protocol processing circuitry 614 of the modem platform 610. The application processing circuitry 612 may run various applications for the UE 602 that source/sink application data. The application processing circuitry 612 may further implement one or more layer operations to transmit/receive application data to/from a data network. These layer operations may include transport (for example UDP) and Internet (for example, IP) operations

The protocol processing circuitry 614 may implement one or more of layer operations to facilitate transmission or reception of data over the connection 606. The layer operations implemented by the protocol processing circuitry 614 may include, for example, MAC, RLC, PDCP, RRC and NAS operations.

The modem platform 610 may further include digital baseband circuitry 616 that may implement one or more layer operations that are “below” layer operations performed by the protocol processing circuitry 614 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 610 may further include transmit circuitry 618, receive circuitry 620, RF circuitry 622, and RF front end (RFFE) 624, which may include or connect to one or more antenna panels 626. Briefly, the transmit circuitry 618 may include a digital-to-analog converter, mixer, intermediate frequency (IF) components, etc.; the receive circuitry 620 may include an analog-to-digital converter, mixer, IF components, etc.; the RF circuitry 622 may include a low-noise amplifier, a power amplifier, power tracking components, etc.; RFFE 624 may include filters (for example, surface/bulk acoustic wave filters), switches, antenna tuners, beamforming components (for example, phase-array antenna components), etc. The selection and arrangement of the components of the transmit circuitry 618, receive circuitry 620, RF circuitry 622, RFFE 624, and antenna panels 626 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 614 may include one or more instances of control circuitry (not shown) to provide control functions for the transmit/receive components.

A UE reception may be established by and via the antenna panels 626, RFFE 624, RF circuitry 622, receive circuitry 620, digital baseband circuitry 616, and protocol processing circuitry 614. In some embodiments, the antenna panels 626 may receive a transmission from the AN 604 by receive-beamforming signals received by a plurality of antennas/antenna elements of the one or more antenna panels 626.

A UE transmission may be established by and via the protocol processing circuitry 614, digital baseband circuitry 616, transmit circuitry 618, RF circuitry 622, RFFE 624, and antenna panels 626. In some embodiments, the transmit components of the UE 604 may apply a spatial filter to the data to be transmitted to form a transmit beam emitted by the antenna elements of the antenna panels 626.

Similar to the UE 602, the AN 604 may include a host platform 628 coupled with a modem platform 630. The host platform 628 may include application processing circuitry 632 coupled with protocol processing circuitry 634 of the modem platform 630. The modem platform may further include digital baseband circuitry 636, transmit circuitry 638, receive circuitry 640, RF circuitry 642, RFFE circuitry 644, and antenna panels 646. The components of the AN 604 may be similar to and substantially interchangeable with like-named components of the UE 602. In addition to performing data transmission/reception as described above, the components of the AN 608 may perform various logical functions that include, for example, RNC functions such as radio bearer management, uplink and downlink dynamic radio resource management, and data packet scheduling.

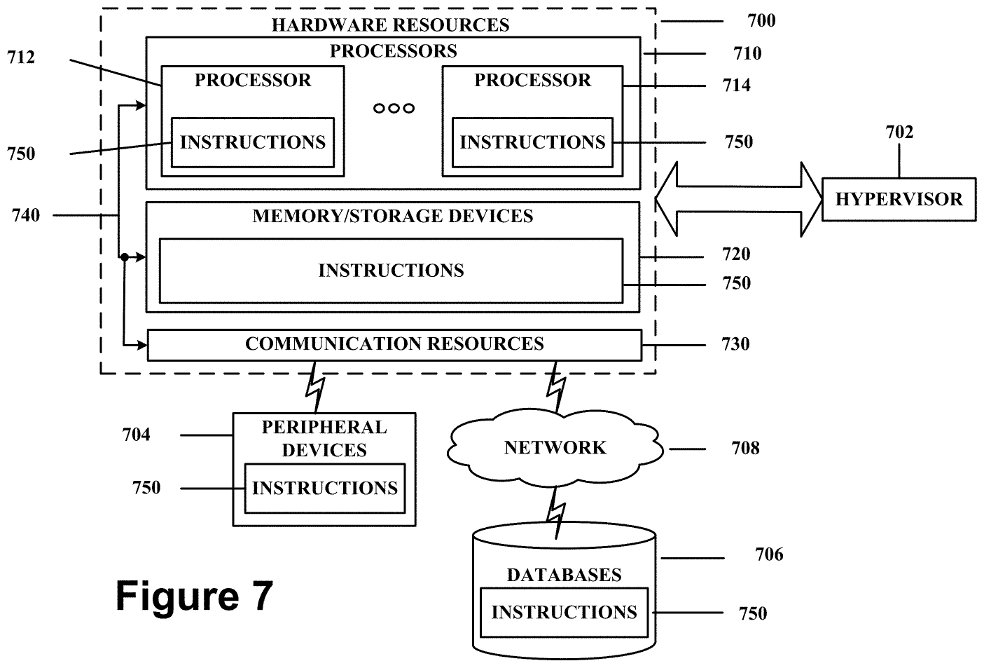

FIG. 7 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 7 shows a diagrammatic representation of hardware resources 700 including one or more processors (or processor cores) 710, one or more memory/storage devices 720, and one or more communication resources 730, each of which may be communicatively coupled via a bus 740 or other interface circuitry. For embodiments where node virtualization (e.g., NFV) is utilized, a hypervisor 702 may be executed to provide an execution environment for one or more network slices/sub-slices to utilize the hardware resources 700.

The processors 710 may include, for example, a processor 712 and a processor 714. The processors 710 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 720 may include main memory, disk storage, or any suitable combination thereof. The memory/storage devices 720 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 730 may include interconnection or network interface controllers, components, or other suitable devices to communicate with one or more peripheral devices 704 or one or more databases 706 or other network elements via a network 708. For example, the communication resources 730 may include wired communication components (e.g., for coupling via USB, Ethernet, etc.), cellular communication components, NFC components, Bluetooth® (or Bluetooth® Low Energy) components, Wi-Fi® components, and other communication components.

Instructions 750 may comprise software, a program, an application, an applet, an app, or other executable code for causing at least any of the processors 710 to perform any one or more of the methodologies discussed herein. The instructions 750 may reside, completely or partially, within at least one of the processors 710 (e.g., within the processor's cache memory), the memory/storage devices 720, or any suitable combination thereof. Furthermore, any portion of the instructions 750 may be transferred to the hardware resources 700 from any combination of the peripheral devices 704 or the databases 706. Accordingly, the memory of processors 710, the memory/storage devices 720, the peripheral devices 704, and the databases 706 are examples of computer-readable and machine-readable media.

### Example Procedures

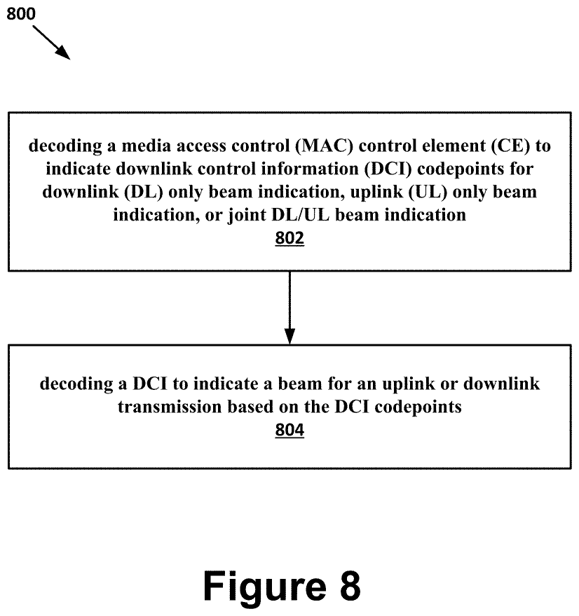

In some embodiments, the electronic device(s), network(s), system(s), chip(s) or component(s), or portions or implementations thereof, of FIGS. 5-7, or some other figure herein, may be configured to perform one or more processes, techniques, or methods as described herein, or portions thereof. One such process 800 is depicted in FIG. 8. In some embodiments, the process 800 may be performed by a UE or a portion thereof. At 802, the process 800 may include decoding a media access control (MAC) control element (CE) to indicate downlink control information (DCI) codepoints for downlink (DL) only beam indication, uplink (UL) only beam indication, or joint DL/UL beam indication. At 804, the process 800 may further include decoding a DCI to indicate a beam for an uplink or downlink transmission based on the DCI codepoints.

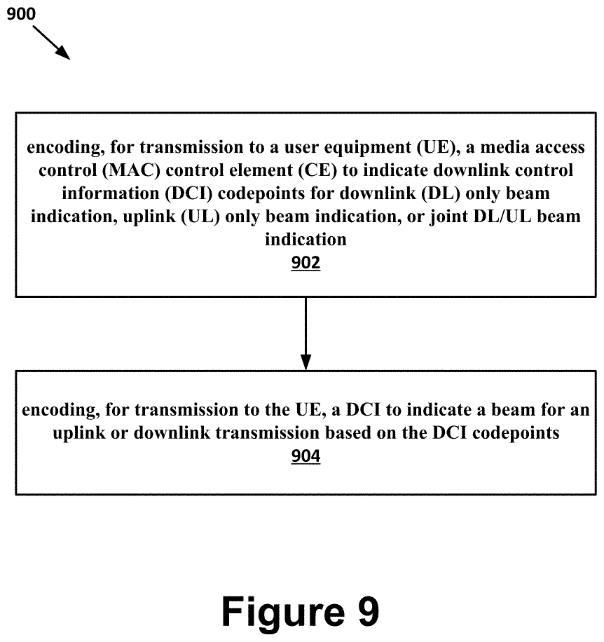

FIG. 9 illustrates another process 900 in accordance with various embodiments. The process 900 may be performed by a gNB or a portion thereof. At 902, the process 900 may include encoding, for transmission to a user equipment (UE), a media access control (MAC) control element (CE) to indicate downlink control information (DCI) codepoints for downlink (DL) only beam indication, uplink (UL) only beam indication, or joint DL/UL beam indication. At 904, the process 900 may further include encoding, for transmission to the UE, a DCI to indicate a beam for an uplink or downlink transmission based on the DCI codepoints.

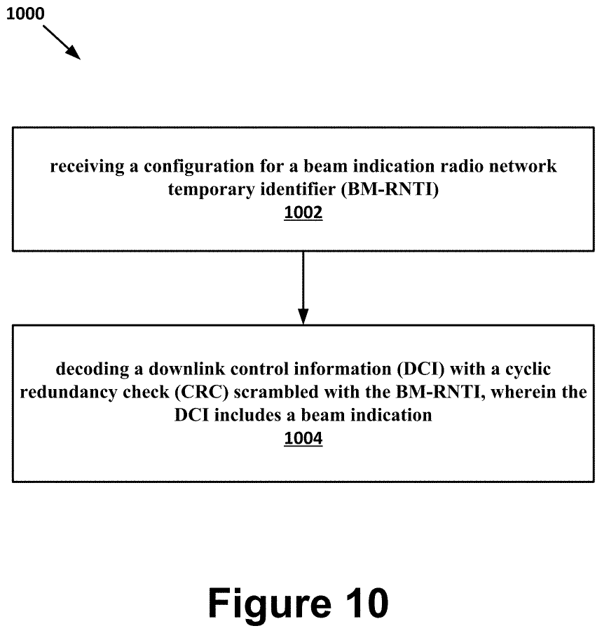

FIG. 10 illustrates another process 1000 in accordance with various embodiments. The process 1000 may be performed by a UE or a portion thereof. At 1002, the process 1000 may include receiving a configuration for a beam indication radio network temporary identifier (BM-RNTI). At 1004, the process 1000 may further include decoding a downlink control information (DCI) with a cyclic redundancy check (CRC) scrambled with the BM-RNTI, wherein the DCI includes a beam indication.

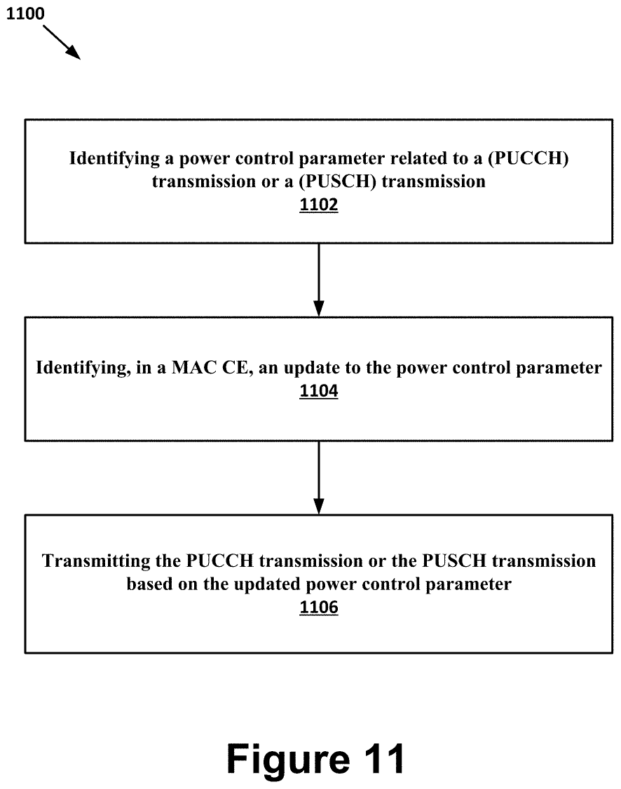

FIG. 11 illustrates another process 1100 in accordance with various embodiments. The process 1100 may be performed by a UE or a portion thereof. The process 1100 may include identifying, at 1102, a power control parameter related to a physical uplink control channel (PUCCH) transmission or a physical uplink shared channel (PUSCH) transmission; identifying, at 1104 in a medium access control (MAC) control element (CE), an update to the power control parameter; and transmitting, at 1106, the PUCCH transmission or the PUSCH transmission based on the updated power control parameter.

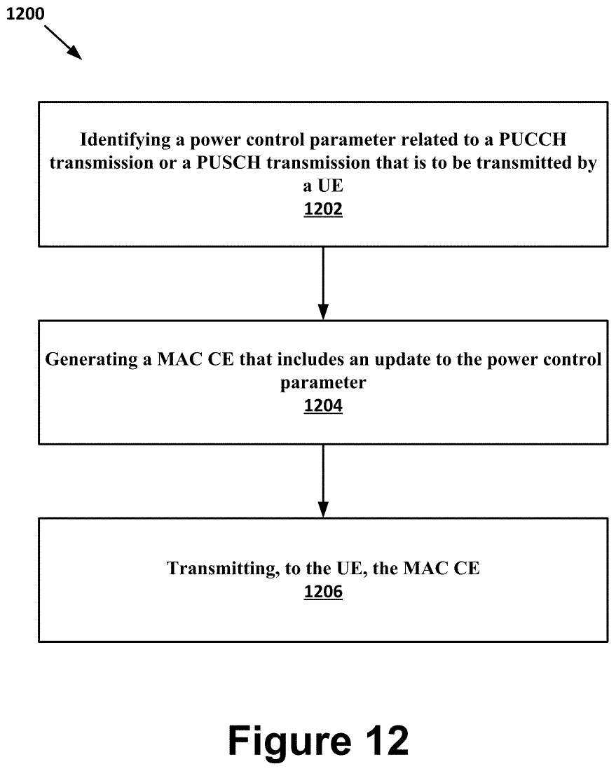

FIG. 12 illustrates another process 1200 in accordance with various embodiments. The process 1200 may be performed by a base station or a portion thereof. The process 1200 may include identifying, at 1202, a power control parameter related to a physical uplink control channel (PUCCH) transmission or a physical uplink shared channel (PUSCH) transmission that is to be transmitted by a user equipment (UE); generating, at 1204, a medium access control (MAC) control element (CE) that includes an update to the power control parameter; and transmitting, at 1206 to the UE, the MAC CE.

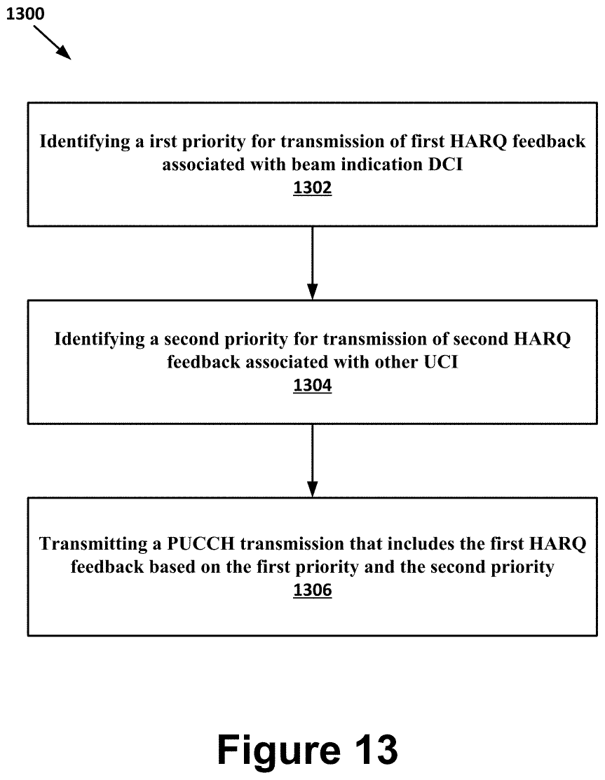

FIG. 13 illustrates another process 1300 in accordance with various embodiments. The process 1300 may be performed by a UE or a portion thereof. The process 1300 may include identifying, at 1302, a first priority for transmission of first hybrid automatic repeat request (HARQ) feedback associated with beam indication downlink control information (DCI); identifying, at 1304, a second priority for transmission of second HARQ feedback associated with other uplink control information (UCI); and transmitting, at 1306, a physical uplink control channel (PUCCH) transmission that includes the first HARQ feedback based on the first priority and the second priority.

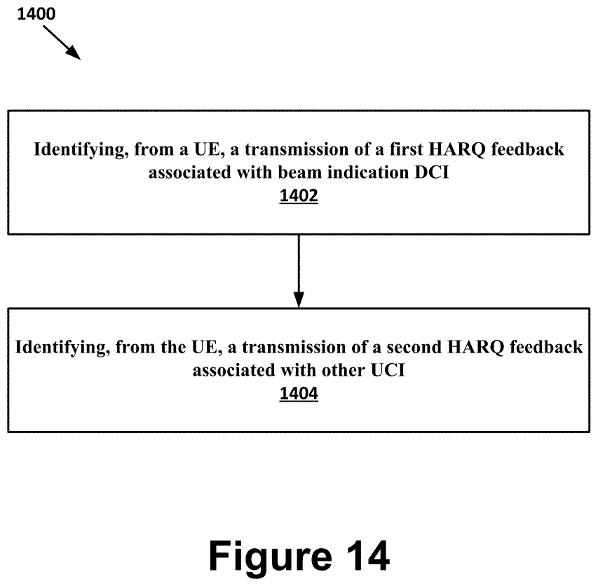

FIG. 14 illustrates another process 1400 in accordance with various embodiments. The process 1400 may be performed by a base station or a portion thereof. The process 1400 may include identifying, at 1402 from a user equipment (UE), a transmission of a first hybrid automatic repeat request (HARQ) feedback associated with beam indication downlink control information (DCI); and identifying, at 1404 from the UE, a transmission of a second HARQ feedback associated with other uplink control information (UCI). In some embodiments, the first transmission is transmitted with a first priority and the second transmission is transmitted with a second priority.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

Example A1 includes one or more non-transitory computer-readable media (NTCRM) having instructions, stored thereon, that when executed by one or more processors of a user equipment (UE), cause the UE to: decode a media access control (MAC) control element (CE) to indicate downlink control information (DCI) codepoints for downlink (DL) only beam indication, uplink (UL) only beam indication, or joint DL/UL beam indication; and decode a DCI to indicate a beam for an uplink or downlink transmission based on the DCI codepoints.

Example A2 includes the one or more NTCRM of example A1 and/or some other example herein, wherein the beam indications for the UL only beam indication and the joint DL/UL beam indication are based on respective TCI states selected from a TCI state pool that is shared for the UL only beam indication and the joint DL/UL beam indication.

Example A3 includes the one or more NTCRM of example A2 and/or some other example herein, wherein the MAC CE further includes an indication of whether a TCI state corresponds to the joint DL/UL TCI state or the UL only TCI state.

Example A4 includes the one or more NTCRM of example A2 and/or some other example herein, wherein the TCI states are configured with a sounding reference signal (SRS) as a source reference signal for UL only beam indication.

Example A5 includes the one or more NTCRM of example A1 and/or some other example herein, wherein the beam indications are based on respective TCI states selected from different TCI state pools for UL-only beam indication and joint DL/UL beam indication.

Example A6 includes the one or more NTCRM of any one of examples A1-A5 and/or some other example herein, wherein the MAC CE includes a field that is to have: a first value to indicate a single TRP transmission with a single TCI state configured for a respective DCI codepoint of the DCI codepoints, wherein the TCI state is a DL TCI state or a joint DL/UL TCI state; or a second value to indicate a multi-TRP transmission with at least two DL TCI states configured for the respective DCI codepoint.

Example A7 includes the one or more NTCRM of example A6 and/or some other example herein, wherein the field of the MAC CE is further to have a third value to indicate a single TRP transmission with a single TCI state configured for the respective DCI codepoint, wherein the TCI state is a joint DL/UL TCI state configured for UL only beam indication.

Example A8 includes the one or more NTCRM of example A7 and/or some other example herein, wherein the field of the MAC CE is further to have a fourth value to indicate that a DL TCI state applicable to DL-only beam indication is configured for a first TCI state of the respective DCI codepoint, and a joint DL/UL TCI state applicable to UL only beam indication is configured to a second TCI state of the respective DCI codepoint.

Example A9 includes one or more non-transitory computer-readable media (NTCRM) having instructions, stored thereon, that when executed by one or more processors of a next generation Node B (gNB), cause the gNB to: encode, for transmission to a user equipment (UE), a media access control (MAC) control element (CE) to indicate downlink control information (DCI) codepoints for downlink (DL) only beam indication, uplink (UL) only beam indication, or joint DL/UL beam indication; and encode, for transmission to the UE, a DCI to indicate a beam for an uplink or downlink transmission based on the DCI codepoints.

Example A10 includes the one or more NTCRM of example A9 and/or some other example herein, wherein the beam indications for the UL only beam indication and the joint DL/UL beam indication are based on respective TCI states selected from a TCI state pool that is shared for the UL only beam indication and the joint DL/UL beam indication.

Example A11 includes the one or more NTCRM of example A10 and/or some other example herein, wherein the MAC CE further includes an indication of whether a TCI state corresponds to the joint DL/UL TCI state or the UL only TCI state.

Example A12 includes the one or more NTCRM of example A10 and/or some other example herein, wherein the TCI states are configured with a sounding reference signal (SRS) as a source reference signal for UL only beam indication.

Example A13 includes the one or more NTCRM of example A9 and/or some other example herein, wherein the beam indications are based on respective TCI states selected from different TCI state pools for UL-only beam indication and joint DL/UL beam indication.

Example A14 includes the one or more NTCRM of any one of examples A9-A13 and/or some other example herein, wherein the MAC CE includes a field that is to have: a first value to indicate a single TRP transmission with a single TCI state configured for a respective DCI codepoint of the DCI codepoints, wherein the TCI state is a DL TCI state or a joint DL/UL TCI state; or a second value to indicate a multi-TRP transmission with at least two DL TCI states configured for the respective DCI codepoint.

Example A15 includes the one or more NTCRM of example A14 and/or some other example herein, wherein the field of the MAC CE is further to have a third value to indicate a single TRP transmission with a single TCI state configured for the respective DCI codepoint, wherein the TCI state is a joint DL/UL TCI state configured for UL only beam indication.

Example A16 includes the one or more NTCRM of example A15 and/or some other example herein, wherein the field of the MAC CE is further to have a fourth value to indicate that a DL TCI state applicable to DL-only beam indication is configured for a first TCI state of the respective DCI codepoint, and a joint DL/UL TCI state applicable to UL only beam indication is configured to a second TCI state of the respective DCI codepoint.

Example A17 includes the or more non-transitory computer-readable media (NTCRM) having instructions, stored thereon, that when executed by one or more processors of a user equipment (UE), cause the UE to: receive a configuration for a beam indication radio network temporary identifier (BM-RNTI); and decode a downlink control information (DCI) with a cyclic redundancy check (CRC) scrambled with the BM-RNTI, wherein the DCI includes a beam indication.

Example A18 includes the one or more NTCRM of example A17 and/or some other example herein, wherein the DCI includes a field with a value to indicate that the DCI is a beam indication DCI.

Example A19 includes the one or more NTCRM of example A16 and/or some other example herein, wherein the field is a frequency domain resource assignment (FDRA) field.

Example A20 includes the one or more NTCRM of example A17 and/or some other example herein, wherein the DCI does not include an associated uplink (UL) or downlink (DL) grant.

Example A21 includes the one or more NTCRM of any one of examples A17-A20 and/or some other example herein, wherein the DCI is a group-common DCI to indicate a TCI state update for multiple UEs.

Example B1 includes a method for uplink and/or joint uplink and downlink TCI state indication and activation.

Example B2 includes the method of example B1 and/or some other example(s) herein, wherein the uplink and possibly joint uplink downlink TCI states share a common TCI state pool with existing downlink TCI states.

Example B3 includes the method of examples B1-B2 and/or some other example(s) herein, wh wherein MAC-CE is used to activate a sub-set of the RRC configured TCI states herein.

Example B4 includes the method of examples B1-B3 and/or some other example(s) herein, wherein TCI state indication is performed by DCI signaling.

Example B5 includes the method of example B4 and/or some other example(s) herein, wherein DCI can indicate a single TCI state ID which is applicable to multiple channels signaled by an activation bitmap in the DCI.

Example B6 includes the method of example B4 and/or some other example(s) herein, wherein the DCI can indicate multiple TCI states applicable to multiple channels in order of the indicated bitmap in the DCI.

Example B7 includes the method of examples B4-B6 and/or some other example(s) herein, wherein the DCI also contains optionally information related to specific channels and reference signals which are applicable if only the respective channel is indicated in the activation bitmap.

Example B8 includes the method of examples B4-B6 and/or some other example(s) herein, wherein the DCI can be transmitted to a group of UEs over a CSS and DCI with CRC scrambled by a group common RNTI which is shared by the group of UEs receiving the DCI.

Example B9 includes the method of examples B4-B8 and/or some other example(s) herein, wherein the DCI can be transmitted to a group of UEs over a CSS and DCI with CRC scrambled by a group common RNTI which is shared by the group of UEs receiving the DCI.

Example B10 may include the methods of examples B4-B9 or some other example herein, wherein the group common DCI indicates the same TCI states and channels to all UEs

Example B11 may include the methods of examples B4-B10 or some other example herein, wherein the group common DCI can indicate UE specific TCI states and respective applicable channels and reference signals. The UE is configured by dedicated RRC or another group common DCI to identify the relevant bits from the group common DCI.

Example B12 includes the method of examples B1-B11 and/or some other example(s) herein, wherein the method is performed by a user equipment (UE) or a Radio Access Network (RAN) node.

Example B13 may include a method comprising:

receiving a MAC CE to indicate DCI codepoints for DL only beam indication, UL only beam indication, and/or joint DL/UL beam indication; and

receiving a DCI to indicate a beam based on the DCI codepoints.

Example B14 may include the method of example B13 and/or some other example herein, wherein the beam indications are based on respective TCI states selected from a same TCI state pool.

Example B15 may include the method of example B14 and/or some other example herein, wherein the MAC CE further includes an indication of whether a TCI state corresponds to a joint DL/UL TCI state or a UL only TCI state.

Example B16 may include the method of example B13 and/or some other example herein, wherein the beam indications are based on respective TCI states selected from different TCI state pools.

Example B17 may include the method of example B13-16 and/or some other example herein, wherein the method is performed by a UE or a portion thereof.

Example C1 may include a method to be performed by a user equipment (UE), wherein the method comprises: identifying a power control parameter related to a physical uplink control channel (PUCCH) transmission or a physical uplink shared channel (PUSCH) transmission; identifying, in a medium access control (MAC) control element (CE), an update to the power control parameter; and transmitting the PUCCH transmission or the PUSCH transmission based on the updated power control parameter.

Example C2 may include the method of example C1, and/or some other example herein, wherein the power control parameter is PUCCH-PowerControl or a PUSCH-PowerControl.

Example C3 may include the method of example C1, and/or some other example herein, wherein the update relates to a pathloss reference reference signal (RS).

Example C4 may include the method of example C1, and/or some other example herein, wherein the MAC CE includes an indication of one or more transmission control indication (TCI) codepoints that indicate a mapping between TCI states and a sounding reference signal (SRS) resource indicator (SRI), and the update to the power control parameter is based on the SRI.

Example C5 may include the method of example C4, and/or some other example herein, wherein the SRI is further used for TCI state indication.

Example C6 may include a method to be performed by a base station, wherein the method comprises: identifying a power control parameter related to a physical uplink control channel (PUCCH) transmission or a physical uplink shared channel (PUSCH) transmission that is to be transmitted by a user equipment (UE); generating a medium access control (MAC) control element (CE) that includes an update to the power control parameter; and transmitting, to the UE, the MAC CE.

Example C7 may include the method of example C6, and/or some other example herein, wherein the power control parameter is PUCCH-PowerControl or a PUSCH-PowerControl.

Example C8 may include the method of example C6, and/or some other example herein, wherein the update relates to a pathloss reference reference signal (RS).

Example C9 may include the method of example C6, and/or some other example herein, wherein the MAC CE includes an indication of one or more transmission control indication (TCI) codepoints that indicate a mapping between TCI states and a sounding reference signal (SRS) resource indicator (SRI), and the update to the power control parameter is based on the SRI.

Example C10 may include the method of example C9, and/or some other example herein, wherein the SRI is further used for TCI state indication.

Example C11 may include a method to be performed by a user equipment (UE), wherein the method comprises: identifying a first priority for transmission of first hybrid automatic repeat request (HARQ) feedback associated with beam indication downlink control information (DCI); identifying a second priority for transmission of second HARQ feedback associated with other uplink control information (UCI); and transmitting a physical uplink control channel (PUCCH) transmission that includes the first HARQ feedback based on the first priority and the second priority.

Example C12 may include the method of example C11, and/or some other example herein, wherein the UE is configured to assign the first priority to be higher than the second priority based on the first priority being related to HARQ feedback associated with beam indication DCI.

Example C13 may include the method of example C11, and/or some other example herein, wherein the first priority is associated with priority index 1.

Example C14 may include the method of example C11, and/or some other example herein, wherein the UE is to identify: the PUCCH transmission of the first HARQ feedback will at least partially overlap in time with a second PUCCH transmission of the second HARQ feedback; and drop transmission of the second PUCCH transmission.

Example C15 may include the method of example C11, and/or some other example herein, wherein the UE is to identify: the PUCCH transmission of the first HARQ feedback will at least partially overlap in time with a second PUCCH transmission of the second HARQ feedback; and multiplex the first and second PUCCH transmissions.

Example C16 may include a method to be performed by a base station, wherein the method comprises: identifying, from a user equipment (UE), a transmission of a first hybrid automatic repeat request (HARQ) feedback associated with beam indication downlink control information (DCI); and identifying, from the UE, a transmission of a second HARQ feedback associated with other uplink control information (UCI); wherein the first transmission is transmitted with a first priority and the second transmission is transmitted with a second priority.

Example C17 may include the method of example C16, and/or some other example herein, wherein the configured to assign the first priority is higher than the second priority based on the first priority being related to HARQ feedback associated with beam indication DCI.

Example C18 may include the method of example C16, and/or some other example herein, wherein the first priority is associated with priority index 1.

Example C19 may include the method of example C16, and/or some other example herein, wherein the first transmission and the second transmission are multiplexed together.

Example C20 may include the method of example C19, and/or some other example herein, wherein the first transmission and the second transmission are multiplexed by the UE based on the first transmission and the second transmission at least partially overlapping in time.

Example Z01 may include an apparatus comprising means to perform one or more elements of a method described in or related to any of examples A1-A21, B1-B17, C1-C20, and/or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples A1-A21, B1-B17, C1-C20, and/or any other method or process described herein.

Example Z03 may include an apparatus comprising logic, modules, or circuitry to perform one or more elements of a method described in or related to any of examples A1-A21, B1-B17, C1-C20, and/or any other method or process described herein.

Example Z04 may include a method, technique, or process as described in or related to any of examples A1-A21, B1-B17, C1-C20, and/or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples A1-A21, B1-B17, C1-C20, and/or portions thereof.

Example Z06 may include a signal as described in or related to any of examples A1-A21, B1-B17, C1-C20, and/or portions or parts thereof.

Example Z07 may include a datagram, packet, frame, segment, protocol data unit (PDU), or message as described in or related to any of examples A1-A21, B1-B17, C1-C20, and/or portions or parts thereof, or otherwise described in the present disclosure.

Example Z08 may include a signal encoded with data as described in or related to any of examples A1-A21, B1-B17, C1-C20, and/or portions or parts thereof, or otherwise described in the present disclosure.

Example Z09 may include a signal encoded with a datagram, packet, frame, segment, protocol data unit (PDU), or message as described in or related to any of examples A1-A21, B1-B17, C1-C20, and/or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples A1-A21, B1-B17, C1-C20, and/or portions thereof.

Example Z11 may include a computer program comprising instructions, wherein execution of the program by a processing element is to cause the processing element to carry out the method, techniques, or process as described in or related to any of examples A1-A21, B1-B17, C1-C20, and/or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

| | | |
|---|---|---|
| 3GPP Third Generation | ARQ Automatic | Temporary |
| Partnership | Repeat Request | Identity |
| Project | AS Access Stratum | CA Carrier |
| 4G Fourth | ASN.1 Abstract Syntax | Aggregation, |
| Generation | Notation One | Certification |
| 5G Fifth Generation | AUSF Authentication | Authority |
| 5GC 5G Core network | Server Function | CAPEX CAPital |
| ACK | AWGN Additive | Expenditure |
| Acknowledgement | White Gaussian | CBRA Contention |
| | Noise | Based Random |
| AF Application | BAP Backhaul | Access |
| Function | Adaptation Protocol | CC Component |
| AM Acknowledged | BCH Broadcast | Carrier, Country |
| Mode | Channel | Code, Cryptographic |
| AMBRAggregate | BER Bit Error Ratio | Checksum |
| Maximum Bit Rate | BFD Beam | CCA Clear Channel |
| AMF Access and | Failure Detection | Assessment |
| Mobility | BLER Block Error Rate | CCE Control Channel |
| Management | BPSK Binary Phase | Element |
| Function | Shift Keying | CCCH Common |
| AN Access Network | BRAS Broadband | Control Channel |
| ANR Automatic | Remote Access | CE Coverage |
| Neighbour Relation | Server | Enhancement |
| AP Application | BSS Business Support | CDM Content Delivery |
| Protocol, Antenna | System | Network |
| Port, Access Point | BS Base Station | CDMA Code- |
| API Application | BSR Buffer Status | Division Multiple |
| Programming Interface | Report | Access |
| APN Access Point | BW Bandwidth | CFRA Contention Free |
| Name | BWP Bandwidth Part | Random Access |
| ARP Allocation and | C-RNTI Cell | CG Cell Group |
| Retention Priority | Radio Network | CI Cell Identity |
| CID Cell-ID (e.g., | CPICHCommon Pilot | CSI-RS CSI |
| positioning method) | Channel | Reference Signal |
| CIM Common | CQI Channel Quality | CSI-RSRP CSI |
| Information Model | Indicator | reference signal |
| CIR Carrier to | CPU CSI processing | received power |
| Interference Ratio | unit, Central | CSI-RSRQ CSI |
| CK Cipher Key | Processing Unit | reference signal |
| CM Connection | C/R | received quality |
| Management, | Command/Response | CSI-SINR CSI |
| Conditional | field bit | signal-to-noise and |
| Mandatory | CRAN Cloud Radio | interference ratio |
| CMAS Commercial | Access Network, | CSMA Carrier Sense |
| Mobile Alert Service | Cloud RAN | Multiple Access |
| CMD Command | CRB Common | CSMA/CA CSMA |
| CMS Cloud | Resource Block | with collision |
| Management System | CRC Cyclic | avoidance |
| CO Conditional | Redundancy Check | CSS Common Search |
| Optional | CRI Channel-State | Space, Cell- specific |
| CoMP Coordinated | Information Resource | Search Space |
| Multi-Point | Indicator, CSI-RS | CTS Clear-to-Send |
| CORESET Control | Resource | CW Codeword |
| Resource Set | Indicator | CWS Contention |
| COTS Commercial | C-RNTI Cell | Window Size |
| Off-The-Shelf | RNTI | D2D Device- |
| CP Control Plane, | CS Circuit Switched | to-Device |
| Cyclic Prefix, | CSAR Cloud Service | DC Dual |
| Connection Point | Archive | Connectivity, Direct |
| CPD Connection Point | CSI Channel-State | Current |
| Descriptor | Information | DCI Downlink |
| CPE Customer | CSI-IM CSI | Control |
| Premise | Interference | Information |
| Equipment | Measurement | |
| DF Deployment | ECCE Enhanced | EN-DC E-UTRA- |
| Flavour | Control Channel | NR Dual |
| DL Downlink | Element, | Connectivity |
| DMTF Distributed | Enhanced CCE | EPC Evolved Packet |
| Management Task | ED Energy | Core |
| Force | Detection | EPDCCH enhanced |
| DPDK Data Plane | EDGE Enhanced | PDCCH, enhanced |
| Development Kit | Datarates for GSM | Physical |
| DM-RS, DMRS | Evolution (GSM | Downlink Control |
| Demodulation | Evolution) | Cannel |
| Reference Signal | EGMF Exposure | EPRE Energy per |
| DN Data network | Governance | resource element |
| DRB Data Radio | Management | EPS Evolved Packet |
| Bearer | Function | System |
| DRS Discovery | EGPRS Enhanced | EREG enhanced REG, |
| Reference Signal | GPRS | enhanced resource |
| DRX Discontinuous | EIR Equipment | element groups |
| Reception | Identity Register | ETSI European |
| DSL Domain Specific | eLAA enhanced | Telecommunications |
| Language. Digital | Licensed Assisted | Standards |
| Subscriber Line | Access, | Institute |
| DSLAM DSL | enhanced LAA | ETWS Earthquake and |
| Access Multiplexer | EM Element | Tsunami Warning |
| DwPTS Downlink | Manager | System |
| Pilot Time Slot | eMBB Enhanced | eUICC embedded UICC, |
| E-LAN Ethernet | Mobile | embedded Universal |
| Local Area Network | Broadband | Integrated Circuit |
| E2E End-to-End | EMS Element | Card |
| ECCA extended clear | Management System | E-UTRA Evolved |
| channel | eNB evolved NodeB, | UTRA |
| assessment, | E-UTRAN Node B | E-UTRAN Evolved |
| extended CCA | | UTRAN |
| EV2X Enhanced V2X | FDM Frequency | GGSN Gateway GPRS |
| F1AP F1 Application | Division Multiplex | Support Node |
| Protocol | FDMA Frequency | GLONASS |
| F1-C F1 Control plane | Division Multiple | GLObal′naya |
| interface | Access | NAvigatsionnaya |
| F1-U F1 User plane | FE Front End | Sputnikovaya |
| interface | FEC Forward Error | Sistema (Engl.: |
| FACCH Fast | Correction | Global Navigation |
| Associated Control | FFS For Further | Satellite System) |
| CHannel | Study | gNB Next Generation |
| FACCH/F Fast | FFT Fast Fourier | NodeB |
| Associated Control | Transformation | gNB-CU gNB- |
| Channel/Full rate | feLAA further enhanced | centralized unit, Next |
| FACCH/H Fast | Licensed Assisted | Generation |
| Associated Control | Access, further | NodeB |
| Channel/Half | enhanced LAA | centralized unit |
| rate | FN Frame Number | gNB-DU gNB- |
| FACH Forward Access | FPGA Field- | distributed unit, Next |
| Channel | Programmable Gate | Generation |
| FAUSCH Fast | Array | NodeB |
| Uplink Signalling | FR Frequency | distributed unit |
| Channel | Range | GNSS Global |
| FB Functional Block | G-RNTI GERAN | Navigation Satellite |
| FBI Feedback | Radio Network | System |
| Information | Temporary | GPRS General Packet |
| FCC Federal | Identity | Radio Service |
| Communications | GERAN | GSM Global System |
| Commission | GSM EDGE | for Mobile |
| FCCH Frequency | RAN, GSM EDGE | Communications, |
| Correction CHannel | Radio Access | Groupe Special |
| FDD Frequency | Network | Mobile |
| Division Duplex | | |
| GTP GPRS Tunneling | HSN Hopping | IE Information |
| Protocol | Sequence Number | element |
| GTP-UGPRS | HSPA High Speed | IBE In-Band |
| Tunnelling Protocol | Packet Access | Emission |
| for User Plane | HSS Home Subscriber | IEEE Institute of |
| GTS Go To Sleep | Server | Electrical and |
| Signal (related to | HSUPA High | Electronics |
| WUS) | Speed Uplink Packet | Engineers |
| GUMMEI Globally | Access | IEI Information |
| Unique MME Identifier | HTTP Hyper Text | Element Identifier |
| GUTI Globally Unique | Transfer Protocol | IEIDL Information |
| Temporary UE | HTTPS Hyper | Element Identifier |
| Identity | Text Transfer Protocol | Data Length |
| HARQ Hybrid ARQ, | Secure (https is | IETF Internet |
| Hybrid | http/1.1 over | Engineering Task |
| Automatic | SSL, i.e. port 443) | Force |
| Repeat Request | I-Block | IF Infrastructure |
| HANDO Handover | Information | IM Interference |
| HFN HyperFrame | Block | Measurement, |
| Number | ICCID Integrated | Intermodulation, |
| HHO Hard Handover | Circuit Card | IP Multimedia |
| HLR Home Location | Identification | IMC IMS Credentials |
| Register | IAB Integrated | IMEI International |
| HN Home Network | Access and Backhaul | Mobile |
| HO Handover | ICIC Inter-Cell | Equipment |
| HPLMN Home | Interference | Identity |
| Public Land Mobile | Coordination | IMGI International |
| Network | ID Identity, | mobile group identity |
| HSDPA High | identifier | IMPI IP Multimedia |
| Speed Downlink | IDFT Inverse Discrete | Private Identity |
| Packet Access | Fourier | IMPU IP Multimedia |
| | Transform | PUblic identity |
| IMS IP Multimedia | ISP Internet Service | L1-RSRP Layer 1 |
| Subsystem | Provider | reference signal |
| IMSI International | IWF Interworking- | received power |
| Mobile | Function | L2 Layer 2 (data |
| Subscriber | I-WLAN | link layer) |
| Identity | Interworking | L3 Layer 3 (network |
| IoT Internet of | WLAN | layer) |
| Things | Constraint length | LAA Licensed |
| IP Internet Protocol | of the convolutional | Assisted Access |
| Ipsec IP Security, | code, USIM | LAN Local Area |
| Internet Protocol | Individual key | Network |
| Security | kB Kilobyte (1000 | LBT Listen Before |
| IP-CAN IP- | bytes) | Talk |
| Connectivity Access | kbps kilo-bits per | LCM LifeCycle |
| Network | second | Management |
| IP-M IP Multicast | Kc Ciphering key | LCR Low Chip Rate |
| IPv4 Internet Protocol | Ki Individual | LCS Location |
| Version 4 | subscriber | Services |
| IPv6 Internet Protocol | authentication | LCID Logical |
| Version 6 | key | Channel ID |
| IR Infrared | KPI Key | LI Layer Indicator |
| IS In Sync | Performance Indicator | LLC Logical Link |
| IRP Integration | KQI Key Quality | Control, Low Layer |
| Reference Point | Indicator | Compatibility |
| ISDN Integrated | KSI Key Set | LPLMN Local |
| Services Digital | Identifier | PLMN |
| Network | ksps kilo-symbols per | LPP LTE Positioning |
| ISIM IM Services | second | Protocol |
| Identity Module | KVM Kernel Virtual | LSB Least Significant |
| ISO International | Machine | Bit |
| Organisation for | L1 Layer 1 (physical | LTE Long Term |
| Standardisation | layer) | Evolution |
| LWA LTE-WLAN | Broadcast and Multicast | MGRP Measurement |
| aggregation | Service | Gap Repetition |
| LWIP LTE/WLAN | MBSFN | Period |
| Radio Level | Multimedia | MIB Master |
| Integration with | Broadcast multicast | Information Block, |
| IPsec Tunnel | service Single | Management |
| LTE Long Term | Frequency | Information Base |
| Evolution | Network | MIMO Multiple Input |
| M2M Machine- | MCC Mobile Country | Multiple Output |
| to-Machine | Code | MLC Mobile Location |
| MAC Medium Access | MCG Master Cell | Centre |
| Control (protocol | Group | MM Mobility |
| layering context) | MCOT Maximum | Management |
| MAC Message | Channel | MME Mobility |
| authentication code | Occupancy Time | Management Entity |
| (security/encryption | MCS Modulation and | MN Master Node |
| context) | coding scheme | MnS Management |
| MAC-A MAC | MDAF Management | Service |
| used for | Data Analytics | MO Measurement |
| authentication | Function | Object, Mobile |
| and key | MDAS Management | Originated |
| agreement (TSG | Data Analytics | MPBCH MTC |
| T WG3 context) | Service | Physical Broadcast |
| MAC-IMAC used for | MDT Minimization of | CHannel |
| data integrity of | Drive Tests | MPDCCH MTC |
| signalling messages | ME Mobile | Physical Downlink |
| (TSG T WG3 context) | Equipment | Control CHannel |
| MANO | MeNB master eNB | MPDSCH MTC |
| Management and | MER Message Error | Physical Downlink |
| Orchestration | Ratio | Shared CHannel |
| MBMS | MGL Measurement | |
| Multimedia | Gap Length | |
| MPRACH MTC | mMTCmassive MTC, | NFPD Network |
| Physical Random | massive Machine- | Forwarding Path |
| Access CHannel | Type Communications | Descriptor |
| MPUSCH MTC | MU-MIMO Multi | NFV Network |
| Physical Uplink Shared | User MIMO | Functions |
| Channel | MWUS MTC | Virtualization |
| MPLS MultiProtocol | wake-up signal, MTC | NFVI NFV |
| Label Switching | WUS | Infrastructure |
| MS Mobile Station | NACK Negative | NFVO NFV |
| MSB Most Significant | Acknowledgement | Orchestrator |
| Bit | NAI Network Access | NG Next Generation, |
| MSC Mobile | Identifier | Next Gen |
| Switching Centre | NAS Non-Access | NGEN-DC NG-RAN |
| MSI Minimum | Stratum, Non-Access | E-UTRA-NR Dual |
| System | Stratum layer | Connectivity |
| Information, | NCT Network | NM Network |
| MCH Scheduling | Connectivity Topology | Manager |
| Information | NC-JT Non- | NMS Network |
| MSID Mobile Station | coherent Joint | Management System |
| Identifier | Transmission | N-PoP Network Point of |
| MSIN Mobile Station | NEC Network | Presence |
| Identification | Capability Exposure | NMIB, N-MIB |
| Number | NE-DC NR-E- | Narrowband MIB |
| MSISDN Mobile | UTRA Dual | NPBCH |
| Subscriber ISDN | Connectivity | Narrowband |
| Number | NEF Network | Physical Broadcast |
| MT Mobile | Exposure Function | CHannel |
| Terminated, Mobile | NF Network | NPDCCH |
| Termination | Function | Narrowband |
| MTC Machine-Type | NFP Network | Physical Downlink |
| Communications | Forwarding Path | Control CHannel |
| NPDSCH | NSR Network Service | OSS Operations |
| Narrowband | Record | Support System |
| Physical Downlink | NSSAI Network Slice | OTA over-the-air |
| Shared CHannel | Selection | PAPR Peak-to-Average |
| NPRACH | Assistance | Power Ratio |
| Narrowband | Information | PAR Peak to Average |
| Physical Random | S-NNSAI Single- | Ratio |
| Access CHannel | NSSAI | PBCH Physical |
| NPUSCH | NSSF Network Slice | Broadcast Channel |
| Narrowband | SelectionFunction | PC Power Control, |
| Physical Uplink | NW Network | Personal Computer |
| Shared CHannel | NWUS Narrowband | PCC Primary |
| NPSS Narrowband | wake-up signal, | Component Carrier, |
| Primary | Narrowband WUS | Primary CC |
| Synchronization | NZP Non-Zero Power | PCell Primary Cell |
| Signal | O&M Operation and | PCI Physical Cell ID, |
| NSSS Narrowband | Maintenance | Physical Cell |
| Secondary | ODU2 Optical channel | Identity |
| Synchronization | Data Unit-type 2 | PCEF Policy and |
| Signal | OFDM Orthogonal | Charging |
| NR New Radio, | Frequency Division | Enforcement |
| Neighbour Relation | Multiplexing | Function |
| NRF NF Repository | OFDMA | PCF Policy Control |
| Function | Orthogonal | Function |
| NRS Narrowband | Frequency Division | PCRF Policy Control |
| Reference Signal | Multiple Access | and Charging Rules |
| NS Network Service | OOB Out-of-band | Function |
| NSA Non-Standalone | OOSOut of Sync | PDCP Packet Data |
| operation mode | OPEX OPerating | Convergence Protocol, |
| NSD Network Service | EXpense | Packet Data |
| Descriptor | OSI Other System | Convergence |
| | Information | Protocol layer |
| PDCCH Physical | PNF Physical | PSBCH Physical |
| Downlink Control | Network Function | Sidelink Broadcast |
| Channel | PNFD Physical | Channel |
| PDCP Packet Data | Network Function | PSDCH Physical |
| Convergence Protocol | Descriptor | Sidelink Downlink |
| PDN Packet Data | PNFR Physical | Channel |
| Network, Public | Network Function | PSCCH Physical |
| Data Network | Record | Sidelink Control |
| PDSCH Physical | POC PTT over | Channel |
| Downlink Shared | Cellular | PSFCH Physical |
| Channel | PP, PTP Point-to- | Sidelink Feedback |
| PDU Protocol Data | Point | Channel |
| Unit | PPP Point-to-Point | PSSCH Physical |
| PEI Permanent | Protocol | Sidelink Shared |
| Equipment | PRACH Physical | Channel |
| Identifiers | RACH | PSCell Primary SCell |
| PFD Packet Flow | PRB Physical | PSS Primary |
| Description | resource block | Synchronization |
| P-GW PDN Gateway | PRG Physical | Signal |
| PHICH Physical | resource block | PSTN Public Switched |
| hybrid-ARQ indicator | group | Telephone Network |
| channel | ProSe Proximity | PT-RS Phase-tracking |
| PHY Physical layer | Services, | reference signal |
| PLMN Public Land | Proximity-Based | PTT Push-to-Talk |
| Mobile Network | Service | PUCCH Physical |
| PIN Personal | PRS Positioning | Uplink Control |
| Identification Number | Reference Signal | Channel |
| PM Performance | PRR Packet Reception | PUSCH Physical |
| Measurement | Radio | Uplink Shared |
| PMI Precoding | PS Packet Services | Channel |
| Matrix Indicator | | |
| QAM Quadrature | RAR Random Access | RLM-RS |
| Amplitude | Response | Reference Signal |
| Modulation | RAT Radio Access | for RLM |
| QCI QoS class of | Technology | RM Registration |
| identifier | RAU Routing Area | Management |
| QCL Quasi co- | Update | RMC Reference |
| location | RB Resource block, | Measurement Channel |
| QFI QoS Flow ID, | Radio Bearer | RMSI Remaining MSI, |
| QoS Flow Identifier | RBG Resource block | Remaining Minimum |
| QoS Quality of | group | System |
| Service | REG Resource | Information |
| QPSK Quadrature | Element Group | RN Relay Node |
| (Quaternary) Phase | Rel Release | RNC Radio Network |
| Shift Keying | REQ REQuest | Controller |
| QZSS Quasi-Zenith | RF Radio Frequency | RNL Radio Network |
| Satellite System | RI Rank Indicator | Layer |
| RA-RNTI Random | RIV Resource | RNTI Radio Network |
| Access RNTI | indicator value | Temporary Identifier |
| RAB Radio Access | RL Radio Link | ROHC RObust Header |
| Bearer, Random | RLC Radio Link | Compression |
| Access Burst | Control, Radio | RRC Radio Resource |
| RACH Random Access | Link Control | Control, Radio |
| Channel | layer | Resource Control |
| RADIUS Remote | RLC AM RLC | layer |
| Authentication Dial In | Acknowledged Mode | RRM Radio Resource |
| User Service | RLC UM RLC | Management |
| RAN Radio Access | Unacknowledged Mode | RS Reference Signal |
| Network | RLF Radio Link | RSRP Reference Signal |
| RAND RANDom | Failure | Received Power |
| number (used for | RLM Radio Link | RSRQ Reference Signal |
| authentication) | Monitoring | Received Quality |
| RS SI Received Signal | SAPD Service Access | SDP Session |
| Strength Indicator | Point Descriptor | Description Protocol |
| RSU Road Side Unit | SAPI Service Access | SDSF Structured Data |
| RSTD Reference Signal | Point Identifier | Storage Function |
| Time difference | SCC Secondary | SDU Service Data |
| RTP Real Time | Component Carrier, | Unit |
| Protocol | Secondary CC | SEAF Security Anchor |
| RTS Ready-To-Send | SCell Secondary Cell | Function |
| RTT Round Trip Time | SC-FDMA Single | SeNB secondary eNB |
| Rx Reception, | Carrier Frequency | SEPP Security Edge |
| Receiving, Receiver | Division | Protection Proxy |
| S1AP S1 Application | Multiple Access | SFI Slot format |
| Protocol | SCG Secondary Cell | indication |
| S1-MME S1 for the | Group | SFTD Space-Frequency |
| control plane | SCM Security Context | Time Diversity, SFN |
| S1-U S1 for the user | Management | and frame timing |
| plane | SCS Subcarrier | difference |
| S-GW Serving Gateway | Spacing | SFN System Frame |
| S-RNTI SRNC | SCTP Stream Control | Number or |
| Radio Network | Transmission | Single |
| Temporary | Protocol | Frequency Network |
| Identity | SDAP Service Data | SgNB Secondary gNB |
| S-TMSI SAE | Adaptation Protocol, | SGSN Serving GPRS |
| Temporary Mobile | Service Data | Support Node |
| Station Identifier | Adaptation | S-GW Serving Gateway |
| SA Standalone | Protocol layer | SI System |
| operation mode | SDL Supplementary | Information |
| SAE System | Downlink | SI-RNTI System |
| Architecture Evolution | SDNF Structured Data | Information RNTI |
| SAP Service Access | Storage Network | SIB System |
| Point | Function | Information Block |
| SIM Subscriber | SR Scheduling | SSSG Search Space Set |
| Identity Module | Request | Group |
| SIP Session Initiated | SRB Signalling Radio | SSSIF Search Space Set |
| Protocol | Bearer | Indicator |
| SiP System in | SRS Sounding | SST Slice/Service |
| Package | Reference Signal | Types |
| SL Sidelink | SS Synchronization | SU-MIMO Single |
| SLA Service Level | Signal | User MIMO |
| Agreement | SSB SS Block | SUL Supplementary |
| SM Session | SSBRI SSB Resource | Uplink |
| Management | Indicator | TA Timing Advance, |
| SMF Session | SSC Session and | Tracking Area |
| Management Function | Service | TAC Tracking Area |
| SMS Short Message | Continuity | Code |
| Service | SS-RSRP | TAG Timing Advance |
| SMSF SMS Function | Synchronization | Group |
| SMTC SSB-based | Signal based | TAU Tracking Area |
| Measurement Timing | Reference Signal | Update |
| Configuration | Received Power | TB Transport Block |
| SN Secondary Node, | SS-RSRQ | TBS Transport Block |
| Sequence Number | Synchronization | Size |
| SoC System on Chip | Signal based | TBD To Be Defined |
| SON Self-Organizing | Reference Signal | TCI Transmission |
| Network | Received Quality | Configuration Indicator |
| SpCell Special Cell | SS-SINR | TCP Transmission |
| SP-CSI-RNTISemi- | Synchronization | Communication |
| Persistent CSI RNTI | Signal based Signal to | Protocol |
| SPS Semi-Persistent | Noise and Interference | TDD Time Division |
| Scheduling | Ratio | Duplex |
| SQN Sequence | SSS Secondary | TDM Time Division |
| number | Synchronization | Multiplexing |
| | Signal | |
| TDMA Time Division | Tx Transmission, | UMTS Universal |
| Multiple Access | Transmitting, | Mobile |
| TE Terminal | Transmitter | Telecommunications |
| Equipment | U-RNTI UTRAN | System |
| TEID Tunnel End | Radio Network | UP User Plane |
| Point Identifier | Temporary | UPF User Plane |
| TFT Traffic Flow | Identity | Function |
| Template | UART Universal | URI Uniform |
| TMSI Temporary | Asynchronous | Resource Identifier |
| Mobile | Receiver and | URL Uniform |
| Subscriber | Transmitter | Resource Locator |
| Identity | UCI Uplink Control | URLLC Ultra- |
| TNL Transport | Information | Reliable and Low |
| Network Layer | UE User Equipment | Latency |
| TPC Transmit Power | UDM Unified Data | USB Universal Serial |
| Control | Management | Bus |
| TPMI Transmitted | UDP User Datagram | USIM Universal |
| Precoding Matrix | Protocol | Subscriber Identity |
| Indicator | UDR Unified Data | Module |
| TR Technical Report | Repository | USS UE-specific |
| TRP, TRxP | UDSF Unstructured | search space |
| Transmission | Data Storage Network | UTRA UMTS |
| Reception Point | Function | Terrestrial Radio |
| TRS Tracking | UICC Universal | Access |
| Reference Signal | Integrated Circuit | UTRAN Universal |
| TRx Transceiver | Card | Terrestrial Radio |
| TS Technical | UL Uplink | Access Network |
| Specifications, | UM Unacknowledged | UwPTS Uplink |
| Technical | Mode | Pilot Time Slot |
| Standard | UML Unified | V2I Vehicle-to- |
| TTI Transmission | Modelling Language | Infrastruction |
| Time Interval | | |
| V2P Vehicle-to- | WiMAX | |
| Pedestrian | Worldwide | |
| V2V Vehicle-to- | Interoperability | |
| Vehicle | for Microwave | |
| V2X Vehicle-to- | Access | |
| everything | WLANWireless Local | |
| VIM Virtualized | Area Network | |
| Infrastructure Manager | WMAN Wireless | |
| VL Virtual Link, | Metropolitan Area | |
| VLAN Virtual LAN, | Network | |
| Virtual Local Area | WPANWireless | |
| Network | Personal Area Network | |
| VM Virtual Machine | X2-C X2-Control | |
| VNF Virtualized | plane | |
| Network Function | X2-U X2-User plane | |
| VNFFG VNF | XML extensible | |
| Forwarding Graph | Markup Language | |
| VNFFGD VNF | XRES EXpected user | |
| Forwarding Graph | RESponse | |
| Descriptor | XOR exclusive OR | |
| VNFM VNF Manager | ZC Zadoff-Chu | |
| VoIP Voice-over-IP, | ZP Zero Power | |
| Voice-over- Internet | | |
| Protocol | | |
| VPLMN Visited | | |
| Public Land Mobile | | |
| Network | | |
| VPN Virtual Private | | |
| Network | | |
| VRB Virtual Resource | | |
| Block | | |

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1. A user equipment (UE) comprising:
one or more processors; and
one or more non-transitory computer-readable media comprising instructions that, upon execution of the instructions by the one or more processors, are to cause the UE to:
identify a power control parameter related to a physical uplink control channel (PUCCH) transmission or a physical uplink shared channel (PUSCH) transmission;
identify, in a medium access control (MAC) control element (CE), an update to the power control parameter; and
transmit the PUCCH transmission or the PUSCH transmission based on the updated power control parameter.

2. The UE of claim 1, wherein the power control parameter is PUCCH-PowerControl or a PUSCH-PowerControl.

3. The UE of claim 1, wherein the update relates to a pathloss reference reference signal (RS).

4. The UE of claim 1, wherein the MAC CE includes an indication of one or more transmission control indication (TCI) codepoints that indicate a mapping between TCI states and a sounding reference signal (SRS) resource indicator (SRI), and the update to the power control parameter is based on the SRI.

5. The UE of claim 4, wherein the SRI is further used for TCI state indication.

6. A base station comprising:
one or more processors; and
one or more non-transitory computer-readable media comprising instructions that, upon execution of the instructions by the one or more processors, are to cause the base station to:
identify a power control parameter related to a physical uplink control channel (PUCCH) transmission or a physical uplink shared channel (PUSCH) transmission that is to be transmitted by a user equipment (UE);
generate a medium access control (MAC) control element (CE) that includes an update to the power control parameter; and
transmit, to the UE, the MAC CE.

7. The base station of claim 6, wherein the power control parameter is PUCCH-PowerControl or a PUSCH-PowerControl.

8. The base station of claim 6, wherein the update relates to a pathloss reference reference signal (RS).

9. The base station of claim 6, wherein the MAC CE includes an indication of one or more transmission control indication (TCI) codepoints that indicate a mapping between TCI states and a sounding reference signal (SRS) resource indicator (SRI), and the update to the power control parameter is based on the SRI.

10. The base station of claim 9, wherein the SRI is further used for TCI state indication.

11. A user equipment (UE) comprising:
one or more processors; and
one or more non-transitory computer-readable media comprising instructions that, upon execution of the instructions by the one or more processors, are to cause the UE to:
identify a first priority for transmission of first hybrid automatic repeat request (HARQ) feedback associated with beam indication downlink control information (DCI);
identify a second priority for transmission of second HARQ feedback associated with other uplink control information (UCI); and
transmit a physical uplink control channel (PUCCH) transmission that includes the first HARQ feedback based on the first priority and the second priority.

12. The UE of claim 11, wherein the UE is configured to assign the first priority to be higher than the second priority based on the first priority being related to HARQ feedback associated with beam indication DCI.

13. The UE of claim 11, wherein the first priority is associated with priority index 1.

14. The UE of claim 11, wherein the UE is to:
identify the PUCCH transmission of the first HARQ feedback will at least partially overlap in time with a second PUCCH transmission of the second HARQ feedback; and
drop transmission of the second PUCCH transmission.

15. The UE of claim 11, wherein the UE is to:
identify the PUCCH transmission of the first HARQ feedback will at least partially overlap in time with a second PUCCH transmission of the second HARQ feedback; and
multiplex the first and second PUCCH transmissions.

16. A base station comprising:
one or more processors; and
one or more non-transitory computer-readable media comprising instructions that, upon execution of the instructions by the one or more processors, are to cause the base station to:
identify, from a user equipment (UE), a transmission of a first hybrid automatic repeat request (HARQ) feedback associated with beam indication downlink control information (DCI); and
identify, from the UE, a transmission of a second HARQ feedback associated with other uplink control information (UCI);
wherein the first transmission is transmitted with a first priority and the second transmission is transmitted with a second priority.

17. The base station of claim 16, wherein the configured to assign the first priority is higher than the second priority based on the first priority being related to HARQ feedback associated with beam indication DCI.

18. The base station of claim 16, wherein the first priority is associated with priority index 1.

19. The base station of claim 16, wherein the first transmission and the second transmission are multiplexed together.

20. The base station of claim 19, wherein the first transmission and the second transmission are multiplexed by the UE based on the first transmission and the second transmission at least partially overlapping in time.
